(19) United States
(12) Patent Application Publication
(10) Pub. No.: US 2018/0354819 A1
(43) Pub. Date: Dec. 13, 2018

(54) Fuel Cell For Wastewater Treatment

(71) Applicant: Imperial Innovations Limited, London (GB)

(72) Inventors: Anthony Kucernak, London (GB); Javier Rubio-Garcia, London (GB); Daniel Malko, London (GB)

(21) Appl. No.: 15/780,744

(22) PCT Filed: Dec. 2, 2016
(86) PCT No.: PCT/GB2016/053803

§ 371 Date: Jun. 1, 2018

(30) Foreign Application Priority Data
Dec. 2, 2015 (GB) 1521284.8

(51) Int. Cl. C02F 1/467; H01M 4/88; H01M 4/92; H01M 4/96; H01M 8/0239; H01M 8/0232; H01M 8/08; H01M 8/22

(52) U.S. Cl. CPC C02F 1/4672; C02F 1/4676; H01M 4/8882; H01M 4/926; C02F 2101/34; H01M 8/0239; H01M 8/0232; H01M 8/08; H01M 8/22; H01M 4/96

(57) ABSTRACT

The invention provides a method of treating waste comprising the steps of: providing an electrochemical cell comprising a cathode, and an anode; supplying a waste stream comprising an organic compound which is a liquid or dissolved in a solvent and contacting the anode and cathode with the waste stream; electrochemically oxidising the organic compound at the anode; supplying oxygen to the cathode; electrochemically reducing the oxygen at the cathode; wherein the cathode comprises a poison resistant oxygen reduction catalyst.

### TECHNICAL FIELD

The present invention generally relates to the field of fuel cells, and their use in treating waste water, and/or producing electrical power therefrom.

### BACKGROUND

Industrial and commercial processes, such as food and beverage production, brewing, wine production, biofuel production, refining of petroleum, and the production of industrial or consumer chemicals generate large amounts of waste water, and waste streams that are contaminated with sugars and other high energy organic molecules. The organic contamination in waste water can be quantified with the parameter: chemical oxygen demand (COD). The COD test is commonly used to determine the amount of organic pollutants found in wastewater, thereby making COD a useful indicator of water quality. COD is expressed in milligrams per litre (mg/L), which indicated the mass of oxygen consumed per litre of solution. Therefore, COD refers to the amount of oxidising chemicals (e.g. K₂Cr₂O₇ and H₂SO₄) that are needed to fully oxidise the organic compounds to CO₂ and water. The presence of organic compounds in a waste stream can affect the amount of dissolved oxygen in the waste stream, and thus can pose a threat to living organisms to which the waste stream is exposed. If the COD of the wastewater is too high, it cannot be directly disposed of into municipal waste water treatment plants. COD is measured according to the International Organisation for Standardization test ISO 6060:1989.

Biochemical oxygen demand (BOD) measures the amount of oxygen consumed by microorganisms in decomposing organic matter in a waste stream, over a specific period of time and at a specific temperature (usually 5 days at 20° C.).

The disposal of waste streams having organic contaminants is a difficult and costly problem. Generally, companies emitting waste stream must pay approximately 40 USD per ton to pre-clean the waste stream with expensive and toxic chemicals, or use slow and sensitive biological processes to clean the stream before disposal. If a process produces a waste stream with organic contaminants, the operator of the process will generally either have onsite facilities or use a third party to treat the waste streams to ensure that the amounts of contaminants in these streams comply with the local and/or national regulations prior to disposal into community treatment plants or into lakes, rivers and oceans.

A number of different approaches have been tried for reducing the amount of organic contaminants in waste streams. Currently, the most viable of these approaches includes the microbial generation, and subsequent combustion of methane to generate electricity. See, Christy et al, Renewable and Sustainable Energy Reviews, 2014, 34, 167-173.

Fuel cells have also been suggested for treating waste water. In such a typical low-temperature fuel cell, the electrolyte is an ion conducting membrane. This is necessary, as fuel crossover is detrimental to the performance of the fuel cell, thus the anode and cathode not only have to be separated physically in order to prevent an electrical short circuit, but the membrane also poses a barrier for the unwanted crossover of other molecules. Such membranes are typically expensive, delicate polymers. Moreover, catalysts are necessary at the anode and the cathode to facilitate a reasonable reaction rate. One specific drawback for fuel cells is the sluggish oxygen reduction reaction (ORR). Expensive and scarce precious metals are generally used to accelerate this reaction, such as Pt, Pt alloys or other precious metals.

However, precious metal catalysts, such as platinum catalysts, are highly susceptible to even tiny amounts of poisons, much lower than would, for instance, be expected to occur in a typical waste stream, and exposure to these poisons often results in the irreversible deactivation of such catalysts.

A further problem associated with the use of platinum catalysts is that, in addition to catalysing the reduction of oxygen, they are capable of promoting other reactions which compete with the ORR.

Fuel cells operating on organic molecules have already been reported (Fujiwara et al, Electrochemistry Communications, 2009, 11(2), 390-392). However most of these fuel cells employ the above mentioned membranes. Moreover expensive catalysts (platinum/palladium) are always employed. The poisoning of these catalysts prevents the use of such fuel cells under the demanding conditions that the waste stream poses. Membranes are not only expensive, but the makeup of the waste stream leads to degradation of these membranes, that is, they lose their ionic conductivity leading to reduced performance of the fuel cell.

Microbial fuel cells have been suggested in which the bacteria at the anode consume organic matter and release electrons for the oxygen reduction reaction at a separated cathode (see, for example, Oncescu & Erickson, Scientific Reports, 2013, 3, Article No. 1226; Chaudhuri & Lovley, Nature Biotechnology, 2003, 21, 1229-1232; Sato et al, Electrochemistry Communications, 2005, 7(7), 643-647; He et al, Chemosphere, 2015, 140, 12-17). However the widespread use of these technologies is prevented by major drawbacks. Indeed, any method which uses microbes means that the generation of electricity needs to be conducted in a batch process due to long reaction times. Moreover, delicate process control is necessary in order to ensure the right conditions for the microbes. Additionally microbial fuel cells only achieve very low current densities—hence very large systems are required to achieve useful power levels.

Meng et al (Separation and Purification Technology, 2008, 59, 91-100) highlights the challenges faced when treating wastewater, including membrane fouling and resistance, pH splitting, oxygen diffusion, substrate crossovers, and high cost of commercially available membranes.

The direct electrochemical oxidation of organic compounds such as glucose, alcohols and volatile organic acids has been reported in literature. For instance, Fujiwara et al. (Electrochemistry Communications, 2009, 11(2), 390-392) reached 20 mW/cm² using glucose as a fuel with an alkaline exchange membrane, and using PtRu as a catalyst on both the cathode and anode. However, the equipment reported by Fujiwara et al is unsuitable for use in treating waste streams. This is because the membranes suggested by Fujiwara et al will be subject to fouling. Furthermore, if fuel cell containing a cation exchange (e.g. a proton exchange) membrane is used to treat waste streams, cations such as alkali metal ions or alkaline earth metal ions, present in the waste stream will interfere with the cation (e.g. proton) conduction of the membrane, thereby reducing the efficiency and ultinaely the lifetime of the fuel cell. The same is true if the membrane is an anion exchange membrane, that is, the presence of anions in the waste stream interfere with the conduction of anions across the membrane. In addition, the precious metal catalysts used in Fujiwara et al are highly sensitive to the presence of impurities. Waste streams to be processed will not only contain the organic compounds to be oxidised, but will also contain solids, and other impurities, depending on the nature of the process used to produce the waste stream. The reagents used in Fujiwara et al are of high purity, and thus does not represent the types of waste streams that would be experienced in industry. Thus, if the catalysts set out in Fujiwara et al were used in a process for treating waste streams, they would be poisoned thereby leading to a loss in activity or complete deactivation. It is therefore desirous to provide a fuel cell where catalysts on the anode and cathode are not poisoned by impurities in the waste stream to be treated.

Furthermore, as highlighted above, Fujiwara et al uses a PtRu catalyst to catalyse the oxygen reduction reaction (ORR) at the cathode. During the lifetime of a fuel cell, even if the anode and cathode are separated by a membrane which selectively passes anions or cations (e.g. an alkaline exchange membrane or a cation (e.g. proton) exchange membrane), crossover of reagents between the fuel and the oxidant across the membrane will occur. To date, it is extremely difficult to prevent crossover during the lifetime of an operating fuel cell. Thus, if any glucose from the anode side crosses over to the cathode side in Fujiwara et al, competing reactions will occur at the cathode. This is because the PtRu catalyst catalyses the reaction of both oxygen and glucose, and would therefore lead to a reduction in the efficiency of the fuel cell.

In addition, there is a desire to provide a method for generating electricity which does not rely on fossil fuels, and is effectively “carbon neutral”. It is also desirable to be able to provide a method for generating electricity which does not suffer from the same intermittency issues as wind and solar energy.

Thus the aim of the invention is to provide a way to clean waste streams, such as waste water, and/or to provide a method for generating electricity from a waste stream that overcomes the above-mentioned issues.

### SUMMARY OF THE INVENTION

The present invention provides a method for treating a waste stream comprising the steps of:
a) providing an electrochemical cell (e.g. a fuel cell) comprising a cathode, and an anode,
b) supplying a waste stream comprising an organic compound which is a liquid or dissolved in a solvent and contacting the anode and cathode with the waste stream;
c) electrochemically oxidising the organic compound at the anode,
d) supplying oxygen to the cathode,
e) electrochemically reducing the oxygen at the cathode, wherein the cathode comprises a poison resistant oxygen reduction catalyst.

The present invention also provides a method for producing electrical power comprising the steps of:
a) providing a fuel cell comprising a cathode, and an anode,
b) supplying a waste stream comprising an organic compound which is a liquid or dissolved in a solvent and contacting the anode and cathode with the waste stream;
c) electrochemically oxidising the organic solute at the anode,
d) supplying oxygen to the cathode,
e) electrochemically reducing the oxygen at the cathode,
wherein the cathode comprises a poison resistant oxygen reduction catalyst.

The present invention also provides a process for disinfecting a waste stream, the process comprising the steps of
a) providing an electrochemical cell (e.g. a fuel cell) comprising a cathode, and an anode,
b) supplying a waste stream comprising an organic compound which is a liquid or dissolved in a solvent and contacting the anode and cathode with the waste stream;
c) electrochemically oxidising the organic compound at the anode,
d) supplying oxygen to the cathode,
e) electrochemically reducing the oxygen at the cathode,
wherein the cathode comprises a poison resistant oxygen reduction catalyst, preferably wherein the anode comprises an anode catalyst supported on silver.

### BRIEF DESCRIPTION OF THE FIGURES

FIG. 1 displays an exemplary single cell of the invention that may be an element of a stack.

FIG. 2 is a schematic of an exemplary fuel cell of the invention.

FIG. 3 is a polarisation curve obtained from a fuel cell using “mimic wastewater” as the waste stream, and using indigo carmine as a mediator compound to facilitate the oxidation of the organic solutes.

FIG. 4 is a polarisation curve obtained from a fuel cell using “mimic wastewater” as the waste stream, and using methyl viologen as a mediator compound to facilitate the oxidation of the organic solutes.

FIG. 5 is a polarisation curve obtained from a “direct” glucose fuel cell, using a Pt/Ru/C anode catalyst and pure glucose as the fuel to be treated at the anode.

FIG. 6 is a polarisation curve obtained from a fuel cell using wastewater provided by a sugar factory as the waste stream. The anode catalyst is Pt/Ru/C.

FIG. 7 is a polarisation curve obtained from a fuel cell using wastewater provided by a sugar factory as the waste stream, at 25° C. and at 60° C.

FIG. 8 is a polarisation curve obtained from a fuel cell using wastewater provided by a sugar factory as the waste stream, with and without addition of 0.5M of NaOH.

FIG. 9 is a polarisation curve employing wastewater obtained from a sugar factory and used at a pH of 13 (adjusted with NaOH). The results shown in FIG. 9 were obtained using the Direct Waste Water Fuel Cell, anode: 2 mg Pt/cm2 Pt/Ru/C on Nickel foam, wastewater, 25 mL/min; cathode: 2.8 mg/cm2 Fe/Phen/Z8 catalyst, dry air, 100 sccm.

FIG. 10 is a polarisation curve employing a different batch of wastewater obtained from Tate and Lyle London and used at a pH of 13 (adjusted with NaOH). The initial COD was about 3200 mg/L Direct Waste Water Fuel Cell, anode: 2 mg ₚₜ/cm² Pt/Ru/C on Nickel foam, wastewater, 8 mL/min; cathode: 2.8 mg/cm² SG catalyst, dry air, 100 sccm.

### DEFINITIONS

For the purpose of the present invention, the term “poison resistant catalyst” or “poison resistant cathode catalyst” (also called a “poison tolerant catalyst”) refers to a catalyst which is resistant to poisons, such as organic molecules that typically deactivate platinum based catalysts, for example nitrogen or sulfur containing compounds or salts (e.g. carbohydrates, amines, sulfides, thiols, or benzene and derivatives of benzene, or salts thereof). Therefore, the poison resistant catalyst will continue to function when contacted with a waste stream (e.g. it is capable of functioning in the presence of a variety of compounds, including different organic compounds, and poisons).

A poison resistant catalyst may be capable of not catalysing oxidation reactions which compete with the oxygen reduction reaction or preferably be capable of conducting the oxygen reduction reaction with higher selectivity than other oxidation reactions.

A poison resistant catalyst is generally a carbon-based catalyst, which may be doped with a metal and/or nitrogen and/or sulfur. The metal may be a precious metal (e.g. platinum or palladium), or may be a transition metal which is not a precious metal (e.g. iron, cobalt, manganese, titanium, vanadium, tungsten, molybdenum or chromium).

The poison resistant cathode catalyst may be defined by its elemental composition. Accordingly, the poison resistant cathode catalyst may be defined as a material which comprises:
(a) at least 75 wt % carbon; and
(b) one or more of nitrogen, sulfur, oxygen and transition metal.

Preferably the poison resistant cathode catalyst may comprise:
(a) at least 75 wt % carbon; and
(b) one or more of:
   a. nitrogen in an amount of up to 25 wt %,
   b. oxygen in an amount of up to 25 wt %,
   c. sulfur in an amount of up to 10 wt %, and
   d. transition metal in an amount of up to 25 wt %.

Preferably at least nitrogen is present. For example, the poison resistant cathode catalyst may comprise more than 75 wt % carbon and nitrogen in an amount of up to 25 wt %. Preferably transition metal is also present. For example, the poison resistant cathode catalyst may comprise more than 75 wt % carbon and nitrogen in an amount of up to 25 wt % and optionally transition metal in an amount of up to 25 wt %.

It will be appreciated that when two or more of nitrogen, oxygen, sulfur and transition metal are present, the sum of components (a) and (b) cannot equal more than 100 wt %.

It is understood that the poison resistant cathode catalyst may consist of the above components. In other words, the poison resistant cathode catalyst may consist of at least 75 wt % carbon, and one or more of nitrogen, sulfur, oxygen and/or transition metal. Preferably the poison resistant cathode catalyst consists of:
(a) at least 75 wt % carbon;
(b) and one or more of:
   a. nitrogen in an amount of up to 25 wt %,
   b. oxygen in an amount of up to 25 wt %,
   c. sulfur in an amount of up to 10 wt %, and
   d. transition metal in an amount of up to 25 wt %.

Preferably a poison resistant cathode catalyst consists of more than 75 wt % carbon and nitrogen in an amount of up to 25 wt % (and optionally also containing transition metal in an amount of up to 25 wt %).

Preferably, a poison resistant cathode catalyst comprises (preferably consists of):
(a) from 80-95 wt % carbon; and
(b) 0-10 wt % oxygen, 2-9 wt % nitrogen, 0-2 wt % sulfur, and 0-5 wt % transition metal (preferably wherein transition metal is Iron). Preferably the carbon content lies between 83-95%, the nitrogen content between 3-8 wt % and the transition metal content between 0-3 wt %.

The transition metal referred to in the poison resistant cathode catalyst above may be selected from the group consisting of cobalt, manganese, chromium, iridium, rhodium, iron or a combination thereof. Preferably, the transition metal is iron.

The elemental composition characterisation of poison resistant cathode catalysts may be determined as is standard in the art and as set out in Malko, D., Kucernak, A. & Lopes, T., Nature Communications 7, 13285 (2016) and Malko, D., Lopes, T., Symianakis, E. & Kucernak, A. R., J. Mater. Chem. A 4, 142-152 (2015), the entire contents of which are herein incorporated by reference. For example, the elemental composition may be determined by X-ray photoelectron spectroscopy and/or total reflection X-ray fluorescence.

Total reflection x-ray fluorescence may be carried out, for example, using a Bruker S2 Picofox. For example, samples may be prepared from a suspension of 10 mg of the poison resistant cathode catalyst in 1 mL H₂O (MiliQ 18.2 MΩ·cm), which may contain 1 wt % Triton X-100 (Sigma Aldrich) as surfactant, 0.2 wt % polyvinylalcohol (Mowiol® 4-88, Sigma-Aldrich) as binder and 100 μg Ga, as internal standard (from 1 g/L Standard Solution, TraceCert®, Sigma-Aldrich). 10 μL may be deposited onto a quartz glass sample carrier and dried at room temperature in a laminar flow hood to give a homogenous thin film.

X-ray Photoelectron Spectroscopy (XPS) analyses may be performed, for example, using a Kratos Analytical AXIS UltraDLD spectrometer. For example, a monochromatic aluminium source (Al Kα=1486.6 eV) may be used for excitation. The analyser may be operated in constant pass energy of 40 eV using an analysis area of approximately 700 μm×300 μm. Charge compensation may be applied to minimise charging effects occurring during the analysis. The adventitious C1s (285.0 eV) binding energy (BE) may be used as internal reference. Pressure may be about 10⁻¹⁰ mbar during the experiments. Quantification and simulation of the experimental photopeaks may be carried out using CasaXPS and XPSPEAK41 software. Quantification may be performed using non-linear Shirley background subtraction.

As used herein, wt % means dry weight percentage of said elemental component of the total of weight of the poison resistant cathode catalyst.

The poison tolerant catalyst may be prepared by
(a) providing a reaction mixture comprising a nitrogen containing precursor compound, and optionally comprising a transition metal salt
(b) optionally adding a carbon source or templating agent to the reaction mixture;
(c) polymerising the reaction mixture; and
(d) heating the polymer produced by step c) to a temperature of between about 400° C. to about 1200° C.

Alternatively, the poison tolerant catalyst may be prepared according to the synthesis procedure set out in Proietti E. et al., Nature Communications, 2, 416 (2011), the entire contents of which are herein incorporated by reference. For example, the poison tolerant catalyst may be prepared by
(a) providing a slurry mixture comprising a microporous support (e.g. ZIF-8 (Z8)), a nitrogen containing precursor compound (e.g. phenanthroline), and optionally a transition metal salt (e.g. an iron salt, such as iron(II) acetate) in a solvent (e.g. ethanol and/or deionized water);
(b) drying the slurry mixture to form a catalyst precursor powder;
(c) optionally milling the catalyst precursor powder; and
(d) heating the polymer produced by step c) to a temperature of between about 400° C. to about 1200° C., optionally in Argon or NH₃.

It has been demonstrated that different synthetic routes lead to poison tolerant catalysts with the same underlying working principle (see, for example, Jaouen F. et al., Energy Environ. Sci., 2011,4, 114-130, doi: 10.1039/C0EE00011F, the entire contents of which are herein incorporated by reference). Accordingly, such catalysts are also of use in the methods for treating or disinfecting a waste stream or producing electrical power of the invention.

The method for preparing the poison tolerant catalyst may further comprise a step (e) of washing the heated polymer of step (d) in an acid (for example, sulphuric acid). For example, the step of washing with an acid may be carried out under reflux. The washed poison tolerant catalyst may then be dried before use.

When oxygen and/or sulfur is present in the poison resistant cathode catalyst, the sulfur and/or oxygen containing precursor may be added in step (a) of the methods of preparation of the poison tolerant catalyst described above. When oxygen is present in the poison resistant cathode catalyst, the oxygen may additionally or alternatively be adsorbed onto the surface of the poison resistant cathode catalyst during or after the heat treatment step or drying steps (e.g. during steps (d) or (e)). When oxygen and/or sulfur is present in the poison resistant cathode catalyst, the sulfur and/or oxygen may additionally or alternatively be introduced into the poison resistant cathode catalyst during the acid washing step and/or the subsequent drying step. When nitrogen is not present, the nitrogen containing precursor may be omitted from step (a).

The nitrogen containing precursor compound may be a compound which consists of carbon, hydrogen and nitrogen, and optionally sulphur and/or oxygen. In other words, the compound may consist of hydrogen, carbon and nitrogen, or hydrogen, carbon, nitrogen and oxygen, or hydrogen, carbon, nitrogen and sulphur, or hydrogen, carbon, nitrogen, oxygen and sulphur.

It will be appreciated that the nitrogen containing precursor compound may be a precursor having i) one or more aryl or heteroaryl rings and at least one amine group, -NHR, which is attached directly to the aryl or heteroaryl ring(s), wherein each R is independently selected from H, aliphatic, heteroaliphatic, aryl and heteroaryl; or ii) at least one heteroaryl ring comprising at least one nitrogen atom and/or at least one sulphur atom.

Suitable carbon sources include microporous or nanoporous carbon (e.g. Ketjen Black EC300J (KJ300), EC600JD (KJ600), VulcanXC 72, Cabot PBX 55, Cabot Black Pearls, acetylene black, or Alfa Aesar Super P). Suitable templating agents may comprise, consist essentially of or consist of a metal oxide, metal hydroxide, metal carbonate, metal bicarbonate, metal nitrate, metal oxalate, metal formate, metal acetate or metal sulphate nanopowder of the formula Aⁱ(X^{j})ₙ, wherein A is an alkali metal, an alkaline earth metal, or a group 10-12 transition metal, i is the charge on the metal A, X is a counterion selected from an oxide, hydroxide, carbonate, bicarbonate, nitrate, oxalate, formate, acetate or sulphate, j is the charge on the counterion and i=n×j. Preferably the templating agent comprises, consists essentially of or consists of a metal oxide, metal carbonate or metal bicarbonate. Preferably A is Mg or Ca.

It will be understood that the poison tolerant catalyst may be prepared by:
a) Providing a reaction mixture comprising a precursor having
   i. one or more aryl or heteroaryl rings and at least one amine group, -NHR, which is attached directly to the aryl or heteroaryl ring(s),
   wherein each R is independently selected from H, aliphatic, heteroaliphatic, aryl and heteroaryl; or
   ii. at least one heteroaryl ring comprising at least one nitrogen atom and/or at least one sulphur atom;
b) Polymerising the precursor; and

Heating the polymer produced by step b) to a temperature of between about 400° C. to about 1200° C.

The poison tolerant catalyst may be a non-precious metal catalyst. The non-precious metal catalyst may be less susceptible to poisons than precious metal-based catalysts, and are thus are tolerant of the impurities and components of the waste stream.

It will also be appreciated that the poison tolerant catalyst may be a mediator compound. In other words, the catalyst may be a compound which is reacted at an electrode to generate an in situ reagent which in turn reacts further with the species to be reduced or oxidised. Thus, at the cathode of the fuel cell used in the present invention, the mediator compound is reduced at the cathode to generate an in situ reagent which in turn reduces oxygen. The mediator compound may be ferricyanide ([Fe(CN)₆]³⁻) or an organic dye which may be selected from benzenesulfonic acid, hydroquinone, methyl viologen dichloride or dibromide, indigo carmine (5,5′-indigodisulfonic acid sodium salt), methylene blue (3,7-bis(Dimethylamino)-phenothiazin-5-ium chloride), methylene green ([7-(dimethylamino)-4-nitrophenothiazin-3-ylidene]-dimethylazanium chloride), Meldola's blue (8-Dimethylamino-2,3-benzophenoxazine hemi(zinc chloride) salt), safranin O (3,7-dimethyl-10-phenylphenazin-10-ium-2,8-diamine;chloride), and (2,2,6,6-tetramethylpiperidin-1-yl)oxyl or derivatives thereof. Other examples of suitable mediator compounds are set out in U.S. Pat. No. 7,544,438, U.S. Pat. No. 8,846,266, Eustis et al, Journal of Power Sources, 2014, 248, 133-1140, and Kim et al, Bull. Korean Chem. Soc., 2011, 32 (11), 3849-3850, the entire contents of which are hereby incorporated by reference.

The mediator compound may be dissolved in the waste stream, or it may be fixed to the surface of the electrode.

The term “precious metal” includes platinum, gold, silver, ruthenium, rhenium, rhodium, palladium, and osmium. Therefore, the term “non-precious metal catalyst” describes catalysts which are substantially free of precious metals. By “substantially free”, it is meant that the sum of all precious metals in the catalyst does not exceed 0.01 wt %, preferably 0.005 wt %, even more preferably 0.001 wt %.

The term “carbohydrate” is exchangeable with the term “saccharide”, and describes monosaccharides, disaccharides, oligosaccharides and polysaccharides. Thus, the term “carbohydrate” encompasses sugars, starch and cellulose. Examples of monosaccharides include glucose, galactose, fructose, mannose and ribose. Examples of disaccharides include sucrose, lactose, maltose, isomaltose, isomaltulose, trehalose and trehalulose. As used herein, an oligosaccharide is a saccharide polymer containing from 3 to 9 monosaccharides, and a polysaccharide is a saccharide polymer containing 10 or more monosaccharides. The oligosaccharides may consist of a single type of monosaccharide, e.g. fructose (fructose-oligosaccahrides, FOS), galactose (galactose-oligosaccahrides, GOS), or mannose (mannose-oligosaccahrides, MOS), or they may consist of two or more different types of monosaccharide. Likewise, the polysaccharides may consist of a single type of monosaccharide, or may consist of two or more different types of monosaccharide. Exemplary oligosaccharides and polysaccharides include inulin.

An aliphatic group is a hydrocarbon moiety that may be straight chain or branched and may be completely saturated, or contain one or more units of unsaturation, but which is not aromatic. The term “unsaturated” means a moiety that has one or more double and/or triple bonds. The term “aliphatic” is therefore intended to encompass alkyl, alkenyl or alkynyl groups, and combinations thereof. An aliphatic group is preferably a C₁₋₂₀aliphatic group, that is, an aliphatic group with 1, 2, 3, 4, 5, 6, 7, 8, 9, 10, 11, 12, 13, 14, 15, 16, 17, 18, 19 or 20 carbon atoms. Preferably, an aliphatic group is a C₁₋₁₆ aliphatic, more preferably a C₁₋₁₂ aliphatic, more preferably a C₁₋₁₀ aliphatic, even more preferably a C₁₋₈ aliphatic, such as a C₁₋₆ aliphatic group.

An alkyl group is preferably a “C₁₋₂₀ alkyl group”, that is an alkyl group that is a straight or branched chain with 1 to 20 carbons. The alkyl group therefore has 1, 2, 3, 4, 5, 6, 7, 8, 9, 10, 11, 12, 13, 14, 15, 16, 17, 18, 19 or 20 carbon atoms. Preferably, an alkyl group is a C₁₋₁₆ alkyl, preferably a C₁₋₁₂ alkyl, more preferably a C₁₋₁₀ alkyl, even more preferably a C₁₋₈ alkyl, even more preferably a C₁₋₆ alkyl group. In certain embodiments, an alkyl group is a “C₁₋₆ alkyl group”, that is an alkyl group that is a straight or branched chain with 1 to 6 carbons. The alkyl group therefore has 1, 2, 3, 4, 5 or 6 carbon atoms. Specifically, examples of “C₁₋₂₀ alkyl group” include methyl group, ethyl group, n-propyl group, iso-propyl group, n-butyl group, iso-butyl group, sec-butyl group, tert-butyl group, n-pentyl group, n-hexyl group, n-heptyl group, n-octyl group, n-nonyl group, n-decyl group, n-undecyl group, n-dodecyl group, n-tridecyl group, n-tetradecyl group, n-pentadecyl group, n-hexadecyl group, n-heptadecyl group, n-octadecyl group, n-nonadecyl group, n-eicosyl group, 1,1-dimethylpropyl group, 1,2-dimethylpropyl group, 2,2-dimethylpropyl group, 1-ethylpropyl group, n-hexyl group, 1-ethyl-2-methylpropyl group, 1,1,2-trimethylpropyl group, 1-ethylbutyl group, 1-methylbutyl group, 2-methylbutyl group, 1,1-dimethylbutyl group, 1,2-dimethylbutyl group, 2,2-dimethylbutyl group, 1,3-dimethylbutyl group, 2,3-dimethylbutyl group, 2-ethylbutyl group, 2-methylpentyl group, 3-methylpentyl group and the like. Alkenyl and alkynyl groups are preferably “C₂₋₂₀ alkenyl” and “C₂₋₂₀ alkynyl” respectively, that is an alkenyl or alkynyl group which is a straight chain or branched chain with 2 to 20 carbons. The alkenyl or alkynyl group therefore has 2, 3, 4, 5, 6, 7, 8, 9, 10, 11, 12, 13, 14, 15, 16, 17, 18, 19 or 20 carbon atoms. Preferably, an alkenyl group or an alkynyl group is “C₂₋₁₅ alkenyl” and “C₂₋₁₅ alkynyl”, more preferably “C₂₋₁₂ alkenyl” and “C₂₋₁₂ alkynyl”, even more preferably “C₂₋₁₀ alkenyl” and “C₂₋₁₀ alkynyl”, even more preferably “C₂₋₈ alkenyl” and “C₂₋₈ alkynyl”, most preferably “C₂₋₆ alkenyl” and “C₂₋₆ alkynyl” groups respectively.

A heteroaliphatic group is an aliphatic group as described above, which additionally contains one or more heteroatoms. Heteroaliphatic groups therefore preferably contain from 2 to 21 atoms, preferably from 2 to 16 atoms, more preferably from 2 to 13 atoms, more preferably from 2 to 11 atoms, more preferably from 2 to 9 atoms, even more preferably from 2 to 7 atoms, wherein at least one atom is a carbon atom. Particularly preferred heteroatoms are selected from O, S, N, P and Si. When heteroaliphatic groups have two or more heteroatoms, the heteroatoms may be the same or different.

An alicyclic group is a saturated or partially unsaturated cyclic aliphatic monocyclic or polycyclic (including fused, bridging and spiro-fused) ring system which has from 3 to 20 carbon atoms, that is an alicyclic group with 3, 4, 5, 6, 7, 8, 9, 10, 11, 12, 13, 14, 15, 16, 17, 18, 19 or 20 carbon atoms. Preferably, an alicyclic group has from 3 to 15, more preferably from 3 to 12, even more preferably from 3 to 10, even more preferably from 3 to 8 carbon atoms. The term “alicyclic” encompasses cycloalkyl, cycloalkenyl and cycloalkynyl groups. It will be appreciated that the alicyclic group may comprise an alicyclic ring bearing one or more linking or non-linking alkyl substitutents, such as —CH₂-cyclohexyl.

Cycloalkyl, cycloalkenyl and cycloalkynyl groups have from 3 to 20 carbon atoms. The cycloalkyl, cycloalkenyl and cycloalkynyl groups therefore have 3, 4, 5, 6, 7, 8, 9, 10, 11, 12, 13, 14, 15, 16, 17, 18, 19 or 20 carbon atoms. Cycloalkyl, cycloalkenyl and cycloalkynyl groups preferably have from 3 to 15, more preferably from 3 to 12, even more preferably from 3 to 10, even more preferably from 3 to 8 carbon atoms. When an alicyclic group has from 3 to 8 carbon atoms, this means that the alicyclic group has 3, 4, 5, 6, 7 or 8 carbon atoms. Specifically, examples of the C₃₋₂₀ cycloalkyl group include cyclopropyl, cyclobutyl, cyclopentyl, cyclohexyl, cycloheptyl, adamantyl and cyclooctyl.

A heteroalicyclic group is an alicyclic group as defined above which has, in addition to carbon atoms, one or more ring heteroatoms, which are preferably selected from O, S, N, P and Si. Heteroalicyclic groups preferably contain from one to four heteroatoms, which may be the same or different. Heterocyclic groups preferably contain from 4 to 20 atoms, more preferably from 4 to 14 atoms, even more preferably from 4 to 12 atoms.

An aryl group is a monocyclic or polycyclic ring system having from 5 to 20 carbon atoms. An aryl group is preferably a “C₆₋₁₂ aryl group” and is an aryl group constituted by 6, 7, 8, 9, 10, 11 or 12 carbon atoms and includes condensed ring groups such as monocyclic ring group, or bicyclic ring group and the like. Specifically, examples of “C₆₋₁₀ aryl group” include phenyl group, biphenyl group, indenyl group, naphthyl group or azulenyl group and the like. It should be noted that condensed rings such as indan and tetrahydro naphthalene are also included in the aryl group.

A heteroaryl group is an aryl group having, in addition to carbon atoms, from one to four ring heteroatoms which are preferably selected from O, S, N, P and Si. A heteroaryl group preferably has from 5 to 20, more preferably from 5 to 14 ring atoms. Specifically, examples of a heteroaryl group includes pyridine, imidazole, N-methylimidazole and 4-dimethylaminopyridine.

The term “hydrocarbon” as used herein refers to a branched or unbranched, saturated, partially saturated or unsaturated, cyclic or acyclic compound consisting of hydrogen and carbon atoms. Thus, a hydrocarbon may be a straight chain or branched, acyclic compound which may comprise one or more double or triple carbon-carbon bonds. It will be understood that the hydrocarbon may contain from about 1 to about 20 carbon atoms (although the skilled person will appreciate that if a double or triple bond is present, the hydrocarbon will contain at least 2 carbon atoms). An aromatic hydrocarbon may comprise one or more five or six membered rings. If more than one ring is present, the rings may be linked by a single bond, or may be fused to give larger polycyclic compounds. Exemplary hydrocarbons include methane, ethane, propane, butane (n or iso), pentane (n, iso or cyclo), hexane (n, iso or cyclo), benzene, naphthalene, anthracene, phenanthracene, pyrene, chrysene etc.

The term “alcohol” describes any compound having at least one —OH moiety. Preferably, an alcohol has the formula “R₁—OH”, wherein R₁ is selected from aliphatic, heteroaliphatic, alicyclic, heteroalicyclic, aryl or heteroaryl groups, any of which may be optionally substituted. It will be appreciated that R₁ may be alkyl, or heterocycloalkyl. It will also be appreciated that the alcohol may be a carbohydrate (e.g. a monosaccharide, a disaccharide, etc). Exemplary alcohols include ethanol, glycerol, isomalt, lactitol, maltitol, mannitol, sorbitol, xylitol, and erythritol.

The term “waste stream” encompasses any discharge of liquid waste comprising at least one organic compound. The at least one organic compound may be liquid at the temperature at which the fuel cell operates (e.g. an alcohol such as methanol, ethanol, or glycerol) or the organic compound may be dissolved in a solvent. Thus, the term waste stream encompasses waste water (also written as wastewater), e.g. where the solvent is water. It will be appreciated that the waste stream may comprise one type of organic compound, or a mixture of organic compounds. A waste stream encompasses the effluent from domestic, industrial, commercial or agricultural activities. Thus, the waste stream may be effluent from a petroleum refinery, chemical or petrochemical plant, paper of pulp production, food or beverage production processes (including from breweries, wineries, distilleries, abattoirs, creameries, sugar manufacturers and refineries, confectionary (e.g. chocolate and candy) production,), pharmaceutical or pesticide manufacturing. Preferably the waste stream is from a food or beverage production process.

The waste stream may additionally comprise solids which are suspended or dispersed in the stream. It may also comprise further compounds which are dissolved in the liquid of the stream, such as nitrogen containing compounds (e.g. ammonia, nitrogen heterocycles, amino acids, urea, etc), sulphur containing compounds (e.g. thiocyanates, sulphides, sulphur-containing heterocycles, sulphoxides, and thiosulphates), and salts which may comprise a metal cation (e.g. an alkali metal or alkaline earth metal cation), or a halide anion (e.g. chloride, bromide or iodide). As mentioned above, the presence of such anions and cations can be problematic for the operation of a fuel cell if an anion or cation exchange membrane is used.

In accordance with standard terminology in the field of fuel cells, the term “anode” is used to refer to the electrode at which the oxidation reaction takes place, and the term “cathode” is used to refer to the electrode at which the reduction reaction takes place.

The skilled person will appreciate that the electrochemical reactions may take place at a discrete anode and cathode or they may take place at least partly in the electrolyte or the or separator (if present) and so it may not always be easy to identify a discrete anode and cathode and the main manifestations of the anode and the cathode may simply be the anodic and cathodic current collectors, which facilitate the removal of electrons from an electrode to an external circuit, and the supply of electrons to an electrode from the external circuit respectively.

### DETAILED DESCRIPTION OF THE INVENTION

The present invention is defined by the accompanying claims.

Thus, the present invention relates to a process for treating a waste stream, and/or for generating electrical energy from a waste stream, using a fuel cell to electrochemically oxidise organic compound(s) in the waste stream. For the purposes of the present invention, the cathode comprises a catalyst which is poison resistant (e.g. it may be a carbon-based catalyst, or a non-precious metal catalyst). The electrolyte, which is the waste stream, contacts both the anode and the cathode (e.g. the electrolyte is the same for both the anode and the cathode).

The ability of the cathode catalyst to continue to function when contacted with the waste stream (e.g. to function in the presence of a variety of compounds, including different organic compounds, and one or more additional compounds, such as amine or sulphur containing compounds or salts, and to not be “poisoned”), means that the fuel cell may be provided without a membrane (e.g., an ion exchange membrane). In other words, a porous separator may be used to separate the anode from the cathode, or the fuel cell may not contain a membrane or separator (e.g. the anode and cathode may be separated by a small gap, through which the waste stream is allowed to pass, thereby acting as the electrolyte for both the anode and cathode). It will be appreciated that when the membrane or separator is not present, the anode and cathode are not in direct physical contact, and are spaced far enough apart to avoid an electrical short circuit (e.g. they are not in electrical contact). It will be appreciated that the space between the anode and cathode may be greater than about 1 μm.

Thus, the present invention relates to a method for treating a waste stream, or to a method for generating electrical power, said methods comprising the steps of:
a) Providing a fuel cell comprising a cathode, and an anode,
b) Providing a waste stream comprising an organic compound which is a liquid, or which is dissolved in a solvent, and contacting said waste stream with the anode and cathode
c) electrochemically oxidising, at least in part, the organic compound at the anode,
d) Supplying oxygen to the cathode,
e) Electrochemically reducing the oxygen at the cathode,
   wherein the cathode comprises a poison tolerant (e.g. a non-precious metal) oxygen reduction catalyst.

The fuel cell for use in the present invention does not require an ion conducting membrane. Instead, the fuel cell may comprise a porous separator. Thus, in a configuration where the fuel cell comprises a porous separator, the anode may be in an anode compartment and the cathode may be in a cathode compartment, and the porous separator separated the anode compartment from the cathode compartment. The waste stream is supplied to both the anode compartment and the cathode compartment.

However, as highlighted above, the fuel cell for use in the invention does not require the presence of a membrane or a separator. Thus, when the membrane and separator are absent, the anode and cathode may be in the same compartment, and the waste stream is supplied to said compartment.

The porous separator, if present, is an electrically insulating material which separates the anode compartment from the cathode compartment, and allows charge carrying species to cross between the anode compartment and the cathode compartment, to complete the electrical circuit. In other words, the porous separator does not function to selectively transport ions. Instead, the separator can prevent electrical contact between the anode and cathode, and may minimise their separation in order to minimise the ion conduction path length, which in turn helps to minimise the internal resistance of the fuel cell. It will be appreciated that the porous separator may allow liquid electrolyte to pass between the anode compartment and the cathode compartment.

The porous separator may be made of a non-woven fibre (such as cotton, nylon, polyester(s), glass etc), a polymer film (e.g. polyethylene, polypropylene, poly(tetrafluoroethylene), polyvinyl chloride etc), or a naturally occurring substance such as rubber, asbestos or wood. The porous separator may be made of a hydrogel or a metal organic framework (MOF). It will be appreciated that the porous separators will generally have a range of pore sizes, for example, the pore sizes may be in the range of from about 1 nm to about 1 μm, e.g. from about 5 to 500 nm, such as from about 10 to about 100 nm.

Exemplary porous separators include glass fiber filter paper, and a porous PEEK (polyether ether ketone) separator, and a polypropylene separator (e.g. Whatman porous glass fiber paper, Celgard 25 μm thick microporous polypropylene (0.043 μm pore diameter), and Celgard 110 μm thick microporous polypropylene (0.064 μm pore diameter)).

The cathode is configured to reduce oxygen, and therefore may be a porous gas electrode. However, it will also be appreciated that the cathode may be immersed (completely or in part) in the waste stream.

The waste stream supplied to the fuel cell may contain a number of different compounds and species, which makes the waste stream inherently difficult to treat effectively as many of these species or compounds may “poison” (e.g. reduce the reactivity or efficiency of) the catalysts which are traditionally used in fuel cells. Poisons are more detrimental to the reduction reaction at the cathode, as the presence of such poisons often leads to competing oxidation reactions at the catalyst.

The cathode comprises a poison tolerant catalyst. The poison tolerant catalyst is capable of catalysing the reduction of oxygen, but preferably does not catalyst oxidation reactions.

Thus, when the cathode is exposed to more than one species which is capable of being electrochemically reduced or oxidised (including oxygen), the poison tolerant catalyst preferably selectively catalyses the reduction of oxygen.

Preferably, the poison tolerant catalyst is a carbon-based catalyst, which may be doped with a metal and/or nitrogen and/or sulphur. The metal may be a precious metal, such as platinum or palladium, or may be a transition metal which is not a precious metal (e.g. iron, cobalt, manganese, titanium, vanadium, tungsten, molybdenum and chromium. Preferably, the catalyst is doped with a transition metal which is not a precious metal, or nitrogen.

It will be appreciated that the poison tolerant catalyst may be a non-precious metal catalyst. The non-precious metal catalyst may be less susceptible to poisons than precious metal-based catalysts, and are thus are tolerant of the impurities and components of the waste stream.

For example, the cathode catalyst may be as described in any of WO 2015/049318, U.S. Pat. No. 8,709,295, U.S. Pat. No. 8,518,608, EP 2,109,170, U.S. Pat. No. 7,259,126, US 2013/0323610, U.S. Pat. No. 7,906,251, U.S. Pat. No. 6,689,711, US 2014/0011102, WO 2011/157800, US 2013/0260286, US 2011/0287174, US 2014/0353144, US 2003/0228972, WO 03/032419, US 2011/0123877, US 2010/0048380, US 2012/0028790, US 2014/0193739, WO 2012/114108, WO 2007/124200, US 2014/0050995, and WO 2014/107726, the entire contents of each of which are incorporated by reference. The cathode catalyst may also be as described in Choi et al, J. Phys. Chem. C., 2010, 114, 8048-803 or Strickland et al, Nat. Commun., 2015, 6:7343, DOI: 10.1038/ncomms8343, the entire contents of each of which are incorporated by reference.

In particular, the cathode catalyst may be prepared by:
a) Providing a reaction mixture comprising a precursor having
   i. one or more aryl or heteroaryl rings and at least one amine group, -NHR, which is attached directly to the aryl or heteroaryl ring(s), wherein each R is independently selected from H, aliphatic, heteroaliphatic, aryl and heteroaryl; or
   ii. at least one heteroaryl ring comprising at least one nitrogen atom and/or at least one sulphur atom;
b) Polymerising the precursor; and

Heating the polymer produced by step b) to a temperature of between about 400° C. to about 1200° C.

The above process may additionally comprises adding a templating agent to the process, prior to conducting step c), said templating agent comprising, consisting essentially of or consisting of a metal oxide, metal hydroxide, metal carbonate, metal bicarbonate, metal nitrate, metal oxalate, metal formate, metal acetate or metal sulphate nanopowder of the formula Aⁱ(X^{j})ₙ, wherein A is an alkali metal, an alkaline earth metal, or a group 10-12 transition metal, i is the charge on the metal A, X is a counterion selected from an oxide, hydroxide, carbonate, bicarbonate, nitrate, oxalate, formate, acetate or sulphate, j is the charge on the counterion and i=n×j. Preferably the templating agent comprises, consists essentially of or consists of a metal oxide, metal carbonate or metal bicarbonate. Preferably A is Mg or Ca.

The at least one heteroaryl ring comprising at least one nitrogen atom is preferably selected from pyridine, 2,2′bipyridine, phenanthroline, terpyridine, pyrrole, indole, pyrazine, pyrimidine, pyridazine, quinazoline, quinoline, or a triazine, preferably pyridine.

Preferably, the precursor is selected from:

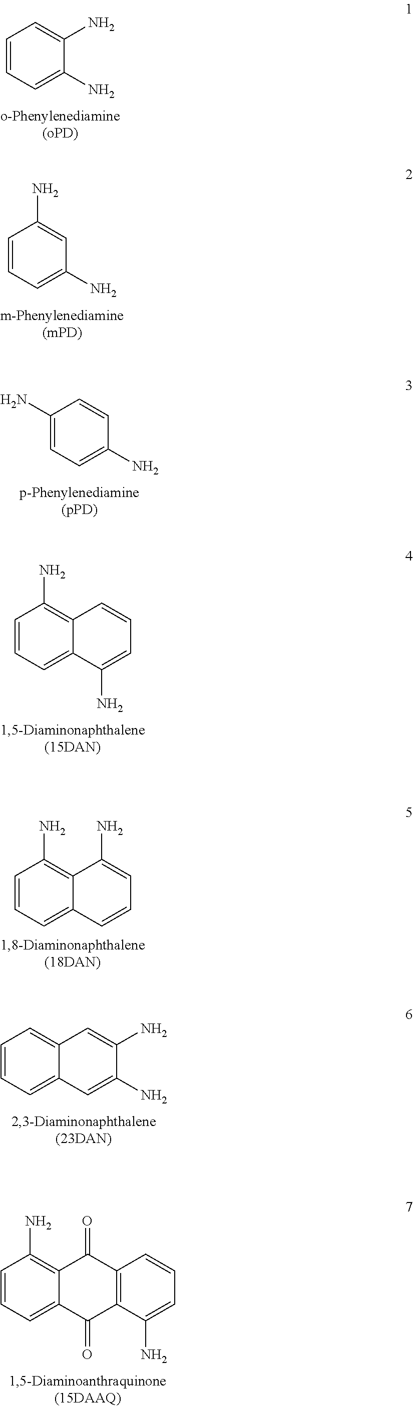

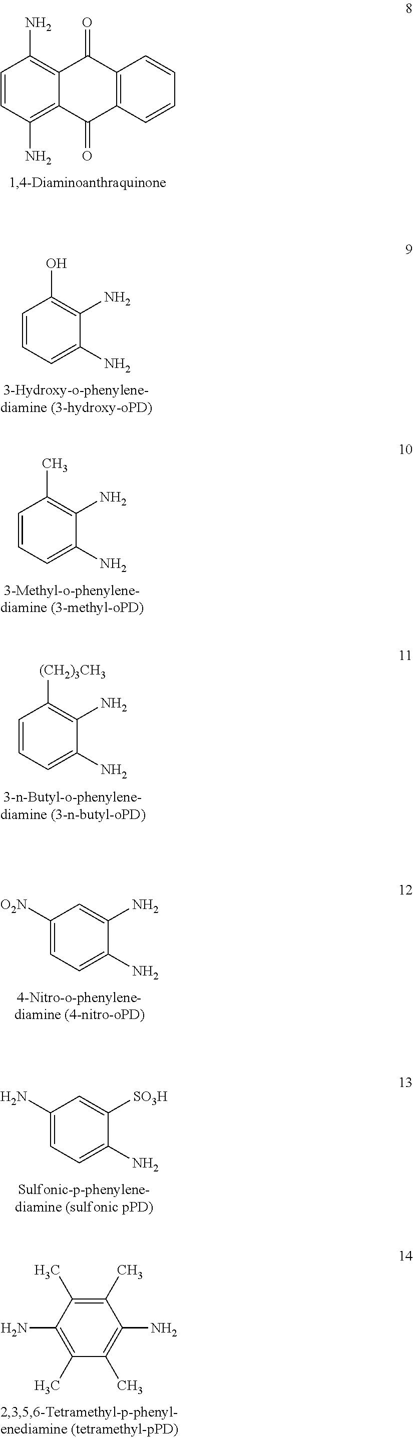

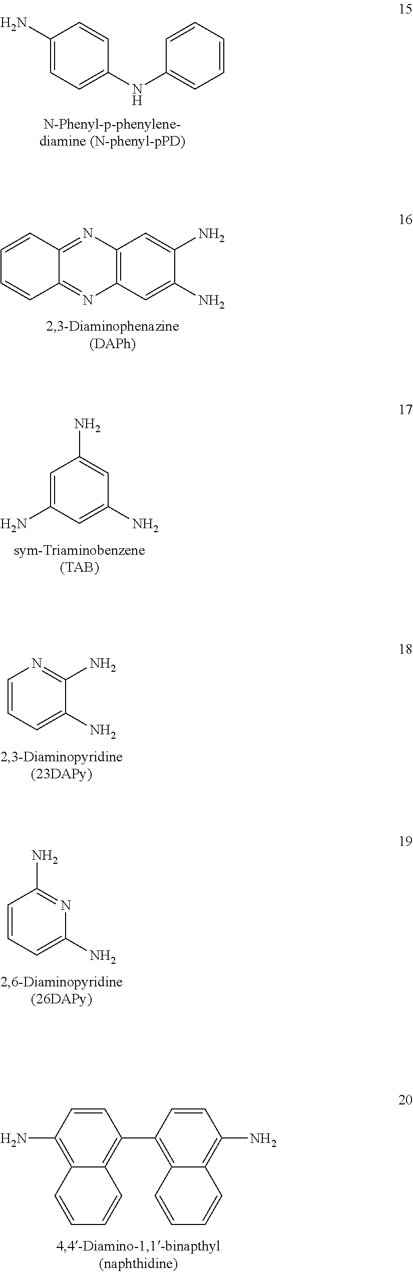 [SMILES: Nc1ccc(Nc2ccccc2)cc1 ; Nc1cc2nc3ccccc3nc2cc1N ; Nc1cc(N)cc(N)c1 ; Nc1cccnc1N ; Nc1cccc(N)n1 ; Nc1ccc(-c2ccc(N)c3ccccc23)c2ccccc12]

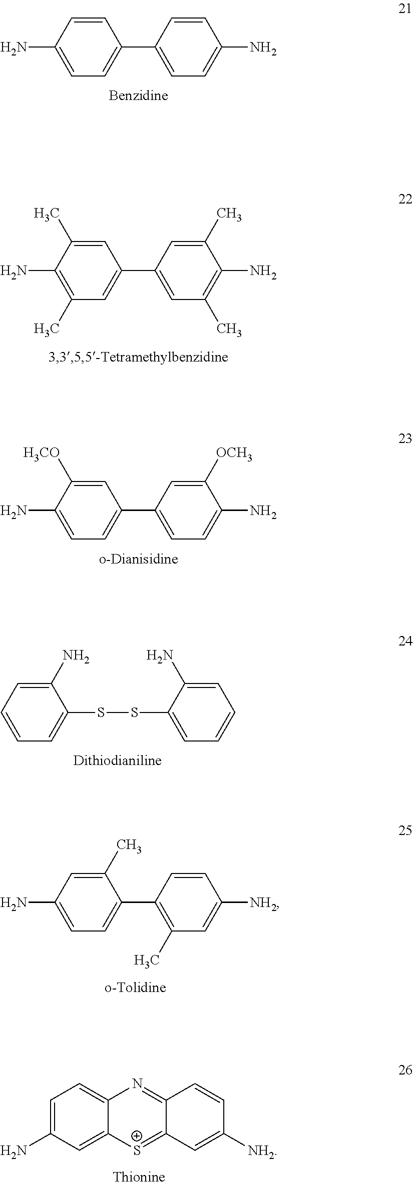 [SMILES: Nc1ccc(-c2ccc(N)cc2)cc1 ; Cc1cc(-c2cc(C)c(N)c(C)c2)cc(C)c1N ; COc1cc(-c2ccc(N)c(OC)c2)ccc1N ; Nc1ccccc1SSc1ccccc1N ; Cc1cc(N)ccc1-c1ccc(N)cc1C ; Nc1ccc2nc3ccc(N)cc3[s+]c2c1]

More preferably, the precursor is selected from 1,5-diaminonaphthalene, 1,2-diaminobenzene, thionine and 1,2-diaminopyridine.

Alternatively, the oxygen may be indirectly electrochemically reduced, which involves reducing a cathode meditator compound at the cathode to generate an in situ reagent which in turn reduces the oxygen. The cathode mediator compound may be ferricyanide ([Fe(CN)₆]³⁻) or an organic dye which may be selected from benzenesulfonic acid, hydroquinone, methyl viologen dichloride or dibromide, indigo carmine (5,5′-indigodisulfonic acid sodium salt), methylene blue (3,7-bis(Dimethylamino)-phenothiazin-5-ium chloride), methylene green ([7-(dimethylamino)-4-nitrophenothiazin-3-ylidene]-dimethylazanium chloride), Meldola's blue (8-Dimethylamino-2,3-benzophenoxazine hemi(zinc chloride) salt), and safranin O (3,7-dimethyl-10-phenylphenazin-10-ium-2,8-diamine;chloride). Other examples of suitable mediator compounds are set out in U.S. Pat. No. 7,544,438, U.S. Pat. No. 8,846,266, Eustis et al, Journal of Power Sources, 2014, 248, 133-1140, and Kim et al, Bull. Korean Chem. Soc., 2011, 32 (11), 3849-3850, the entire contents of which are hereby incorporated by reference. Preferably the cathode mediator compound for the cathode is methylene blue or ferricyanide.

The skilled person will appreciate that, in the context of the present invention, the cathode mediator compound is a “poison tolerant” cathode catalyst.

While the cathode mediator compound may be dissolved in the waste stream, it is preferred that the cathode mediator compound is fixed to the surface of the electrode. This may be achieved, for example, using a diazo coupling reaction, adsorption of the cathode mediator compound onto the electrode surface, or incorporation of the cathode mediator compound into a conducting polymer which, in turn, may be coated to the electrode surface, or used as the electrode itself. This technique is demonstrated, for example, in Kim et al, Bull. Korean Chem. Soc., 2011, 32 (11), 3849-3850, the contents of which are incorporated by reference.

During operation of the fuel cell, an oxygen source is provided to the cathode. The skilled person will appreciate that the waste stream (electrolyte) may contact one side of the cathode, and the oxygen source may contact the other (opposite) side of the cathode. The oxygen source may be oxygen gas (e.g. provided from a container) or may be air. Upon exposure to the cathode, the oxygen is reduced, thereby depleting the amount of oxygen in the oxygen source. The depleted oxygen source may then exit the fuel cell, e.g. through an outlet in the compartment containing the cathode.

The oxygen reduction reaction in aqueous solution occurs mainly by two pathways: the direct 4-electron reduction pathway from O₂ to H₂O (see equation 1) or hydroxide ions (see equation 2), and the 2-electron reduction pathway from O₂ to hydrogen peroxide, H₂O₂ (see equation 3).

O₂+4H⁺+4e⁻ [symbol] 2H₂O (Equation 1)

O₂+4e⁻+2H₂O [symbol] 4OH (Equation 2)

O₂+2H⁺+2e⁻ [symbol] H₂O₂ (Equation 3)

Typically, fuel cells which use the ORR are designed to eliminate the formation of hydrogen peroxide, as it is generally considered to be an unwanted side-product which reduces the power efficiency of the fuel cell, and degrades system components.

However, in the present invention, the formation of hydrogen peroxide can be desirable, as this compound, once generated, can be provided to the waste stream to further reduce the contamination levels of the waste stream. In other words, the hydrogen peroxide may be provided to the waste stream so as to oxidise either solid (undissolved) or dissolved contaminants in the waste stream.

During operation of the fuel cell, a waste stream is provided to the anode which comprises an organic compound which is a liquid, or which is dissolved in a solvent.

The waste stream for use in the present invention comprises one or more organic compounds. The organic compound may be a liquid (e.g. it may be liquid at the temperature at which the fuel cell is operated) or it may be dissolved in the waste stream, in other words the waste stream may comprise a solvent and an organic solute (e.g. the organic compound which is dissolved). It will be appreciated that if an organic compound is solid at room temperature (i.e. about 20° C.), and has partial solubility in the solvent, the part which is dissolved in the solvent is referred to as the “solute”.

Examples of organic compounds which are liquid at room temperature include ethanol, methanol and glycerol. Thus, the waste stream may comprise one or more liquid organic compounds.

If the organic compound is dissolved in the waste stream, the solvent may be water, acetonitrile, an ether, ethyl acetate, a halogenated hydrocarbon (e.g. dichloromethane or dichloroethane), or N-methylpyrrolidone, or it may be a further organic compound, which is liquid (e.g. methanol, ethanol, glycerol, etc.), or a mixture thereof (e.g. glycerol and water, ethanol and water, methanol and waster etc.). Preferably the solvent comprises water, or in other words, the waste stream is preferably a wastewater stream.

It will be appreciated that the term “dissolved” in the context of the invention means that the organic compound is capable of dissolving, at least in part, in a solvent.

The organic compound may be selected from a carbohydrate, an alcohol, an aldehyde, an ester, a ketone, a hydrocarbon, an acid, and amino acid, a protein and combinations thereof.

When the organic compound is a carbohydrate, it may be a monosaccharide (such as glucose, galactose, fructose, mannose and ribose), a disaccharide (such as sucrose, lactose, maltose, isomaltose, isomaltulose, trehalose and trehalulose), an oligosaccharide (such as FOS, MOS or GOS), a polysaccharide (such as inulin), or mixtures thereof.

When the organic compound is an alcohol, it may be selected from a C₁₋₁₀ alcohol, such as methanol, ethanol, glycerol, isomalt, lactitol, maltitol, mannitol, sorbitol, xylitol, and erythritol.

When the organic compound is an acid, it may be a C₁₋₂₀ carboxylic acid or dicarboxylic acid, for example the acid may be selected from citric acid, tartaric acid, malic acid, lactic acid, acetic acid, or propionic acid.

When the organic compound is an amino acid or protein, it may be a selected from bovine serum albumin (BSA), cysteine, lysine, alanine, arginine, asparagine, aspartic acid, glutamine, glutamic acid, glycine, histidine, isoleucine, leucine, methionine, phenylalanine, proline, serine, threonine, tryptophan, tyroinse and valine.

When the organic compound is an ester, it may be selected from ethyl acetate, n-butyl acetate, n-propyl acetate, isopropyl acetate, ethyl formate, and methyl formate.

When the organic compound is an aldehyde, it may be selected from formaldehyde (methanal), acetaldehyde (ethanal), propionaldehyde (propanal), butyraldehyde (butanal), pentanal, benzaldehyde, cinnamaldehyde, vanillin, tolualdehyde, furfural, retinaldehyde, glyoxal, malondialdehyde, succindialdehyde, glutaraldehyde, and phthalaldehyde.

When the organic compound is a ketone, it may be selected from acetone, propanone, butanone, 3-pentanone, cyclohexanone, dimethyl ketone, methyl ethyl ketone, methyl isobutyl ketone, and isophorone.

When the organic compound is a hydrocarbon, it may be a branched or unbranched, saturated, partially saturated or unsaturated, cyclic or acyclic compound consisting of hydrogen and carbon atoms. The hydrocarbon preferably contains from about 1 to about 20 carbon atoms. The hydrocarbon may be an aromatic hydrocarbon which comprises one or more five or six membered rings. If more than one ring is present, the rings may be linked by a single bond, or may be fused to give larger polycyclic compounds. Exemplary hydrocarbons include methane, ethane, propane, butane (n or iso), pentane (n, iso or cyclo), hexane (n, iso or cyclo), benzene, naphthalene, anthracene, phenanthracene, pyrene, chrysene etc.

The nature of the organic compound in the waste stream will depend on the source of the waste stream. For example, if the waste stream is from a winery or a brewery, the waste stream may comprise water, and the organic compound may be selected from a carbohydrate, an alcohol, an acid, an ester, and combinations thereof. Exemplary organic compounds of a winery or brewery waste stream include ethanol, glycerol, phenolic compounds (e.g. tannins), acids (e.g. citric acid, tartaric acid, malic acid, lactic acid and acetic acid), monosaccharides and disaccharides (e.g. glucose and sucrose), and starch.

During operation of the fuel cell, the waste stream comprising the organic compound is supplied to the anode through an inlet in the compartment housing the anode. Upon exposure to the anode, at least a part of the organic compound may be oxidised. The skilled person will appreciate that the organic compound may be completely oxidised (e.g. broken down to carbon dioxide and water), or may be partially oxidised (e.g. increasing the oxidation state of the organic compound). The depleted waste stream may then exit the anode compartment through the outlet in said compartment. The process of the invention lowers the COD of the waste stream entering the fuel cell, by at least partially oxidising the one or more organic compound(s) present in the waste stream.

It will be appreciated that exposing the waste stream to the fuel cell referred to herein will reduce the concentration of the organic compound(s) in the waste stream. For example the concentration of the organic compound(s) in the waste stream directly exiting the fuel cell may be at least about 5% less, preferably at least about 10% less, more preferably at least about 20% less, even more preferably at least about 30% less, even more preferably at least about 50% less, even more preferably about 70% less, even more preferably at least about 90% less, even more preferably at least about 95% less than the concentration of the organic compound(s) in the waste stream directly entering the fuel cell.

It will be appreciated that if the waste stream comprises more than one type of organic compound, the anode may oxidise each of these organic compounds.

The organic compound in the waste stream may be directly electrochemically oxidised at the anode. By “direct electrochemical oxidation”, it is meant that the organic compound is oxidised on the anode surface, without the involvement of other chemical reagents. The oxidation and reduction reactions described herein are 2 electron reactions, and do not involve radical species.

When the organic compound is directly oxidised at the anode, the anode additionally comprises a catalyst. Most non-enzymatic direct glucose fuel cells require the use of a metal-based catalyst to promote both oxidation and reduction reactions at the anode and cathode respectively. This strategy is based on processing the catalyst as a carbon-based ink that is deposited on the surface of a high surface area support. However, when using a catalyst, the reaction mechanism is limited by the mass transport of the organic molecules towards the surface of the catalyst and the kinetic limitations of the employed catalyst. The majority of poisoning of metal based catalysts occurs on the cathode, as oxidation reactions of the “poisons” compete with the reduction reaction. Thus, it is possible to use a metal catalyst on the fuel electrode (anode), and it will not significantly impact the longevity of the fuel cell in question.

Therefore, the anode may comprise a catalyst (hereinafter referred to as the anode catalyst), which is capable of catalysing oxidation reactions. The anode catalyst may comprise platinum, ruthenium, a mixture of platinum and ruthenium, vanadium, palladium, cobalt, manganese, etc. The anode catalyst may be supported on carbon or silver. Silver is known to have antimicrobial properties, and thus using a silver support may assist in the fuel cell's ability to treat the waste stream. Thus, the present disclosure also provides a process for disinfecting a waste stream using a fuel cell as described herein. The term “disinfecting a waste stream” refers to a process which eliminates or reduces the amount of microbes in a waste stream.

Alternatively, the organic compound may be indirectly electrochemically oxidised, which involves oxidising an anode meditator compound at the anode to generate an in situ reagent which in turn oxidises the organic compound to break down the organic solute as set out above. The anode mediator compound may be an organic dye which may be selected from benzenesulfonic acid, hydroquinone, methyl viologen dichloride or dibromide, indigo carmine (5,5′-indigodisulfonic acid sodium salt), methylene blue (3,7-bis(Dimethylamino)-phenothiazin-5-ium chloride), methylene green ([7-(dimethylamino)-4-nitrophenothiazin-3-ylidene]-dimethylazanium chloride), Meldola's blue (8-Dimethylamino-2,3-benzophenoxazine hemi(zinc chloride) salt), and safranin O (3,7-dimethyl-10-phenylphenazin-10-ium-2,8-diamine;chloride). Other examples of suitable mediator compounds are set out in U.S. Pat. No. 7,544,438, U.S. Pat. No. 8,846,266, Eustis et al, Journal of Power Sources, 2014, 248, 133-1140, and Kim et al, Bull. Korean Chem. Soc., 2011, 32 (11), 3849-3850, the entire contents of which are hereby incorporated by reference. Preferably the anode mediator compound is indigo carmine or methyl viologen.

While the anode mediator compound may be dissolved in the waste stream, it is preferred that the mediator compound is fixed to the surface of the electrode. This may be achieved, for example, using a diazo coupling reaction, adsorption of the anode mediator compound onto the electrode surface, or incorporation of the anode mediator compound into a conducting polymer which, in turn, may be coated to the electrode surface, or used as the electrode itself. This technique is demonstrated, for example, in Kim et al, Bull. Korean Chem. Soc., 2011, 32 (11), 3849-3850, the contents of which are incorporated by reference.

The present invention can advantageously be carried out at low temperatures, that is, the invention does not require additional external heat to be supplied. However, it will be appreciated that the waste stream may comprise residual heat, e.g. if it is provided from a reactor which has been subjected to heating. In other words, the waste stream may be provided to the fuel cell at temperatures which exceed the ambient temperature surrounding the fuel cell. Thus, the invention may be carried out at temperatures from about 10° C. and about 150° C., preferably from about 15° C. and about 70° C., more preferably from about 18° C. and about 60° C.

The pH of the waste water can vary widely. For example, the pH of the waste water directly entering the fuel cell may be in the range of between about 1 to about 14. The waste stream may be used in the fuel cell without modification. However, it will be appreciated that one or more additives may be added to the waste stream prior to the waste stream entering the fuel cell. Examples of such additives include a base, such as a group 1 or group 2 metal (e.g. Na, K, Mg or Ca) hydroxide or carbonate, including NaOH, KOH etc, or an acid, such as sulphuric acid, acetic acid, or hydrochloric acid. For example, the acid or base (including NaOH and KOH) may be added, e.g. in a concentration of between 0.1M and 2M, such as about 0.5M or about 1M.

It will be appreciated that, in the methods of the invention, a single fuel cell may be used, or a plurality of fuel cells may be used. Where a plurality is used, they may be connected in series or in parallel to one another.

### DETAILED DESCRIPTION OF FIGURES

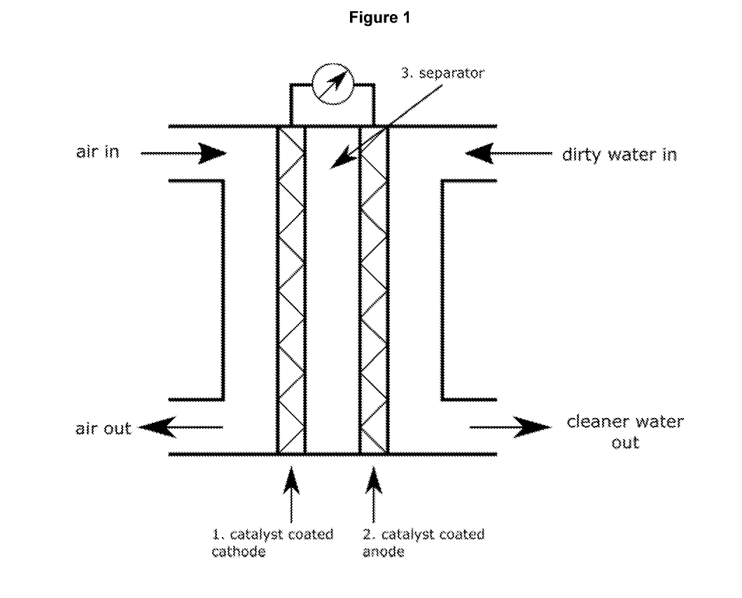

FIG. 1 shows a schematic of a fuel cell for treating a waste stream and/or producing electrical power therefrom. The waste stream (in this instance dirty water) is supplied to the anode, said anode having an anode catalyst, such as a platinum/ruthenium (Pt/Ru) alloy, on the surface. The organic compound(s) in the waste stream are contacted with the anode, where it is electrochemically oxidised. The current is collected by a current collector in the cathode, and the waste water containing the oxidised species is carried away from the anode.

Gaseous air (containing oxygen) is supplied to the cathode, which has a poison resistant catalyst on the surface of said cathode. The oxygen in the air is reduced at the cathode, and the oxygen depleted air is discharged to the atmosphere. The separator allows charge balancing species to pass between the anode and cathode, thereby completing the electrical circuit.

It will be appreciated that although the above apparatus provides that the poison resistant cathode catalyst is on the surface of the cathode, the poison resistant cathode catalyst may also be a mediator compound which is present in the waste stream, or coupled directly to the cathode.

It will also be appreciated that the anode catalyst may be substituted for a mediator compound. In addition, the skilled person will understand that the apparatus described in FIG. 1 will also be capable of functioning without the separator.

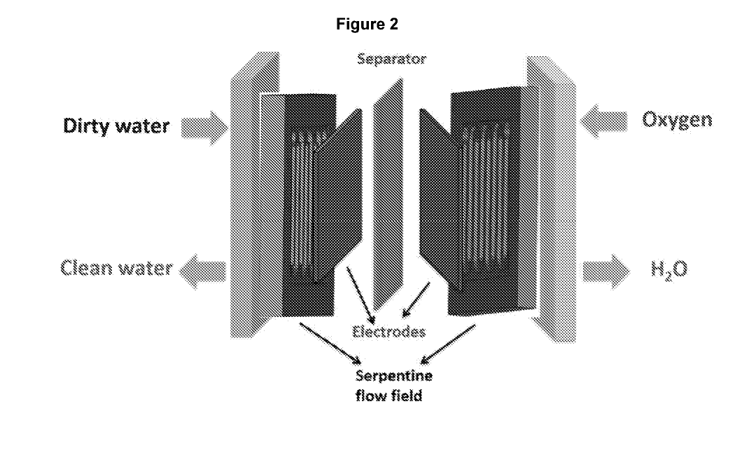

FIG. 2 shows an exploded view of the components of a single cell which may be present in a stack containing a plurality of cells. The stacking of cells and the feeding of fuel/air to a fuel cell is already well known in the field of fuel cells and so further description will be omitted.

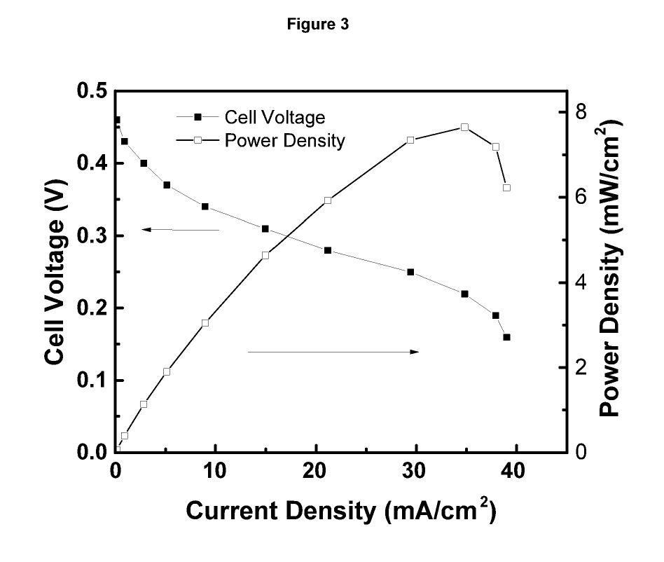

FIGS. 3 to 8 are polarization curves produced using an exemplary fuel cell of the invention. A description of how these curves were produced and the relevance of the results are set out in the Examples section below.

### EXAMPLES

### Example 1

Poison resistant ORR catalyst: The cathode catalyst denoted as SG catalyst was synthesised as follows. In a 250 mL round bottom flask, 1,5-Diaminonaphtalene (1 g, 6.32 mmol) is dissolved in Ethanol (220 mL). A solution of FeCl₂*4H₂O (40 mg, 0.200 mmol) dissolved in ethanol (20 mL) is added to the solution. After 10 Minutes NH₄S₂O₈(1 g, 4.38 mmol) is also added. The mixture is stirred for 24 h. The solvent is removed under reduced pressure and the remaining black powder is subjected to heat treatment in the tube furnace to 950° C.. at a heating rate of 20° C./min for 2 h while supplying a constant stream of inert nitrogen gas. The resulting black powder is refluxed for 8 h in 0.5M H₂SO₄ to remove residual metal. After filtering and drying in the oven at 60° C. over night, the catalyst Fe-ODAN-1% (354 mg) is ready to use.

Cathode preparation: An ink was prepared by ultrasonically homogenising the required amount of catalyst (SG Catalyst), suspended as a 10 wt % suspension in isopropyl alcohol and adding the equivalent amount of Nafion 5wt % solution to reach a catalyst to Nafion weight ratio of 1/1. The ink was then quantitatively deposited onto PTFE treated carbon paper with microporous layer (Toray TGP-H60 baselayered) by means of paint brushing, to reach an end loading of 4 mg/cm² catalyst. After drying the cathode is ready to use.

Pt/Ru Anode preparation: Pt/Ru-Carbon: An ink was prepared by ultrasonically homogenising the required amount of catalyst (HiSpec5000 from Alfa Aesar), suspended as a 10 wt % suspension in isopropyl alcohol and adding the equivalent amount of Nafion 5 wt % solution to reach a catalyst to Nafion weight ratio of 1/1. The ink was then quantitatively deposited onto either carbon paper (SpectraCarbA0850 from FuelCell store invc.) or Nickel foam by means of paint brushing, to reach the desired end loading of 4 mg_{Pt}/cm². After drying the anode is ready to use.

Electrolyte/Fuel preparation: Mediated Glucose Fuel cell: In order to simulate a representative composition of waste water a solution of 0.5M Glucose, 0.25M Sodiumacetate, 0.25M Ringers Solution in 1M KOH was prepared. As a redox mediator either 0.05M indigo carmine (Mediated Glucose Fuel Cell 1) or 0.05M Methylviologen (Mediated Glucose Fuel Cell 2) was added.

Direct Glucose Fuel Cell: A solution of 0.5M Glucose in 1M KOH in deionised water was prepared.

Direct waste water fuel cell: Glucose refining waste water supplied by Tate and Lyle London was directly used as fuel and electrolyte without modification (COD of about 170,000 mg/L).

Single Cell Testing: Single cell tests were performed with a home-made test fixture, comprising a gold coated current collector and graphite serpentine flow field at the anode and cathode side. Cathode, separator and anode were sandwiched between the graphite flow fields. To prevent any leakage, Viton gaskets were used. The liquid electrolyte was pumped with a peristaltic pump and the air was supplied with a compressor and the flow controlled with a mass flow controller. The potential and current were controlled with a Potentiostat/Galvanostat (Autolab 302N).

Results and Discussion

Organic dyes such benzenesulfonic acid, hydroquinone or methyl viologen show reversible redox reactions and high oxidative potential towards organic molecules including glucose. As a result, some of these species have been investigated in the past as aqueous redox mediators enabling oxidation of glucose in direct glucose fuel cells (Liu et al, Applied, Energy, 2013, 106, 176-183). Those systems showed considerable power densities (8 mW cm⁻²) while being limited by the transport of the organic dye towards the electrode. In the literature, only utilization of pure glucose as fuel is reported. This is because the Pt-based catalysts in such systems show a decrease in activity when glucose solutions are used, and are highly susceptible to the presence of any impurities in such solutions. In the present example, the Pt cathode catalyst was replaced by a poison resistant catalyst referred to herein, which is tolerant to poisons and does not catalyse the reaction of glucose. In the fuel cell tested, the oxidation of the organic compound at the anode was promoted using a selection of different organic dyes acting as mediators. The use of the mediator compounds leads to significant and unexpected additional benefits which include not only better performance, but poison tolerance. Thus, the fuel cells of the invention can operate using an inexpensive separator, as it is not necessary to try to prevent cross-over from the anode to the cathode.

The implementation of indigo carmine was explored and, upon optimization of the liquid flow rate and fuel concentration which mimics a realistic waste stream (0.5M Glucose, 0.25M Sodium acetate, 0.25M Ringers Solution in 1M KOH), the polarization curve presented in FIG. 3 was obtained. Compared to the utilization of pure glucose the observed open cell potential (OCP) decreased from 0.51V to 0.47V. As current is forced out of the system a gradual decrease of voltage is observed which leads to a peak power density of 7.8 mW cm⁻² at 0.25V. The results shown in FIG. 3 were obtained using Mediated Glucose Fuel Cell 1, anode: Nickel foam, 1M “mimic waste water”, 1M NaOH, 0.05M indigo carmine, 25 mL/min; cathode: 2.8 mg/cm² SG catalyst, dry air, 550 sccm.

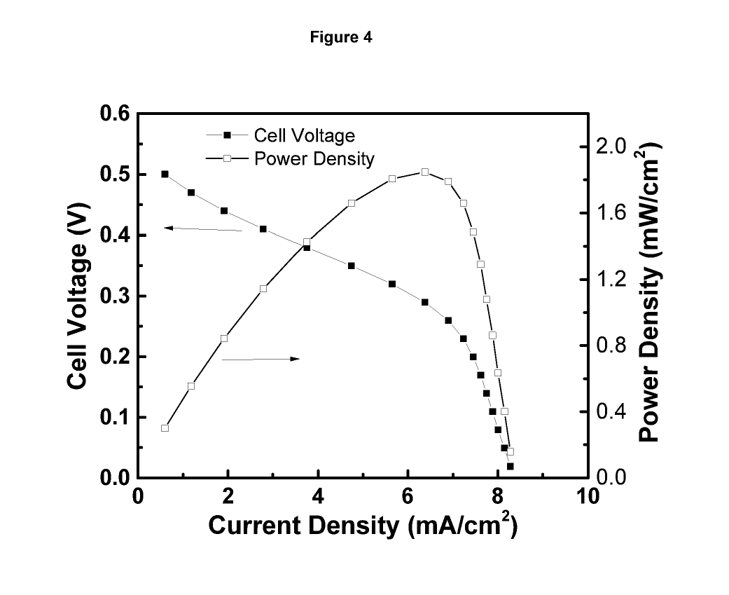

Other organic dyes such methyl viologen were tested showing the ability to oxidize molecules dissolved in the wastewater (FIG. 4). Methyl viologen presents a pH dependent redox activity with best properties between pH 8 and 10. The results shown in FIG. 4 were obtained using mediated Glucose Fuel Cell 2, anode: nickel foam, 1M “mimic waste water”, 1M NaOH, 0.1M methyl viologen, 25 ml/min; cathode: 2.8 mg/cm² SG catalyst, dry air, 550 sccm.

Experiments were then carried out to investigate the direct oxidation of glucose in a fuel cell of the invention.

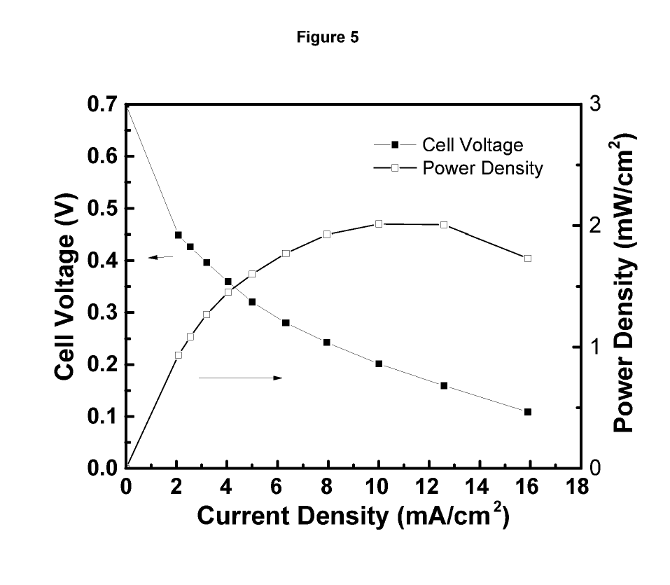

FIG. 5 shows the polarization curve of a cell using pure glucose as fuel. Although the OCP of the cell is substantially higher compared to the organic dye mediator assembly, the peak power in this case is lower; around 2 mW cm⁻². This value is similar to the state of the art for configurations using expensive Nafion membranes. The results shown in FIG. 5 were obtained using the Direct Glucose Fuel Cell, anode: 2 mg _{Pt}/cm² Pt/Ru/C on Nickel foam, 1M Glucose, 1M NaOH, 25 mL/min; cathode: 2.8 mg/cm² SG catalyst, dry air, 500 sccm.

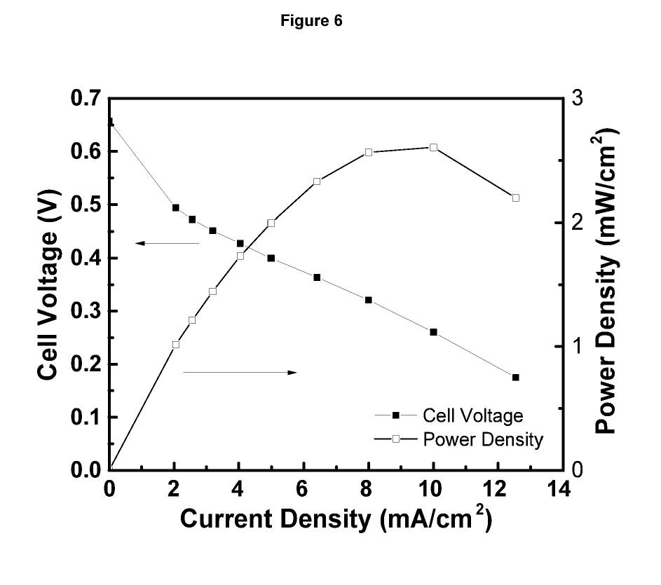

FIG. 6 shows the polarization curve employing wastewater obtained from a sugar factory and used without any further modification. Surprisingly, although the catalyst loading remained unchanged with regards to the use of glucose as a fuel, an increase of peak power density is observed up to 2.7 mW cm⁻². This value, never previously report in the literature, demonstrates the viability of the device here presented as a result of a poison resistant catalytic activity. The results shown in FIG. 6 were obtained using the Direct Waste Water Fuel Cell, anode: 2 mg _{Pt}/cm² Pt/Ru/C on Nickel foam, wastewater, 25 mL/min; cathode: 2.8 mg/cm² SG catalyst, dry air, 500 sccm.

After about 1 hour in the fuel cell at short circuit potential, the COD of the wastewater obtained from a sugar factory was reduced from about 170,000 mg/L to about 130,000 mg/L.

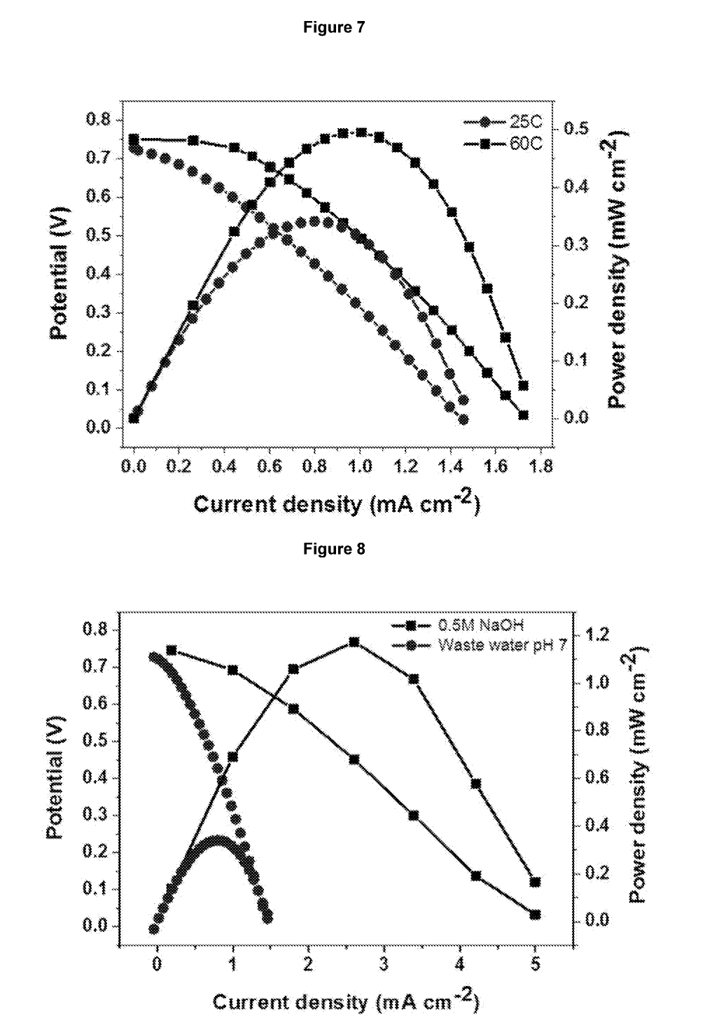

FIG. 7 shows the polarization curve employing wastewater obtained from a sugar factory and used without any further modification, at 25° C. and at 60° C. Better kinetics were observed at 60° C., as compared to 25° C., thereby resulting in a higher system output. The results shown in FIG. 7 were obtained using the Direct Waste Water Fuel Cell, anode: 2 mg _{Pt}/cm² Pt/Ru/C on Nickel foam, wastewater, 2 mL/min; cathode: 2.8 mg/cm² SG catalyst, dry air, 200 mL/min.

FIG. 8 shows the polarization curve employing wastewater obtained from a sugar factory and used without any further modification (at pH 7), and with the addition of 0.5M NaOH. The results show that increasing the ionic conductivity by adding NaOH leads to a higher power output. The results shown in FIG. 8 were obtained using the Direct Waste Water Fuel Cell at 25° C., anode: 2 mg _{Pt}/cm² Pt/Ru/C on Nickel foam, wastewater, 2 mL/min; cathode: 2.8 mg/cm² SG catalyst, dry air, 200 mL/min.

### Example 2

Water Cleaning with Energy Input

Using the Direct Waste Water Fuel Cell, anode: 2 mg _{Pt}/cm² Pt/Ru/C on nickel foam, wastewater as received from sugar factory, 8 mL/min; cathode: 2.8 mg/cm² SG catalyst, dry air, 100 sccm. (as prepared for Example 1), the cell was polarised at −0.1 V for 17h which equates to a mean residence time of ca. 12 minutes and the wastewater was recirculated. The COD decrease was determined to be ca. 14%.

### Example 3

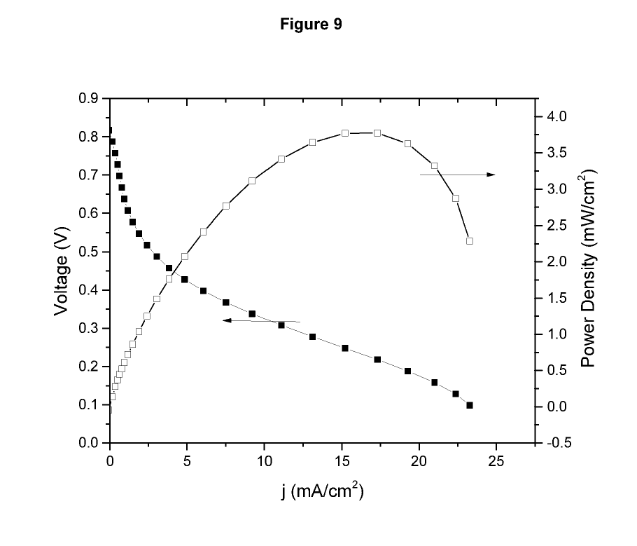

FIG. 9 shows a polarisation curve for a Fe/Phen/Z8 poison tolerant catalyst prepared according to an alternative method as set out in Proietti E. et al., Nature Communications, 2, 416 (2011). A Direct Waste Water Fuel Cell was constructed as set out in Example 1 (using the Fe/Phen/Z8 poison tolerant catalyst in place of the SG catalyst) using waste water supplied by Tate and Lyle London at a pH of 13 (adjusted with NaOH). The COD was reduced by 10% after a recirculation of the liquid that equates to a residence time of ca. 4 minutes.

### Example 4

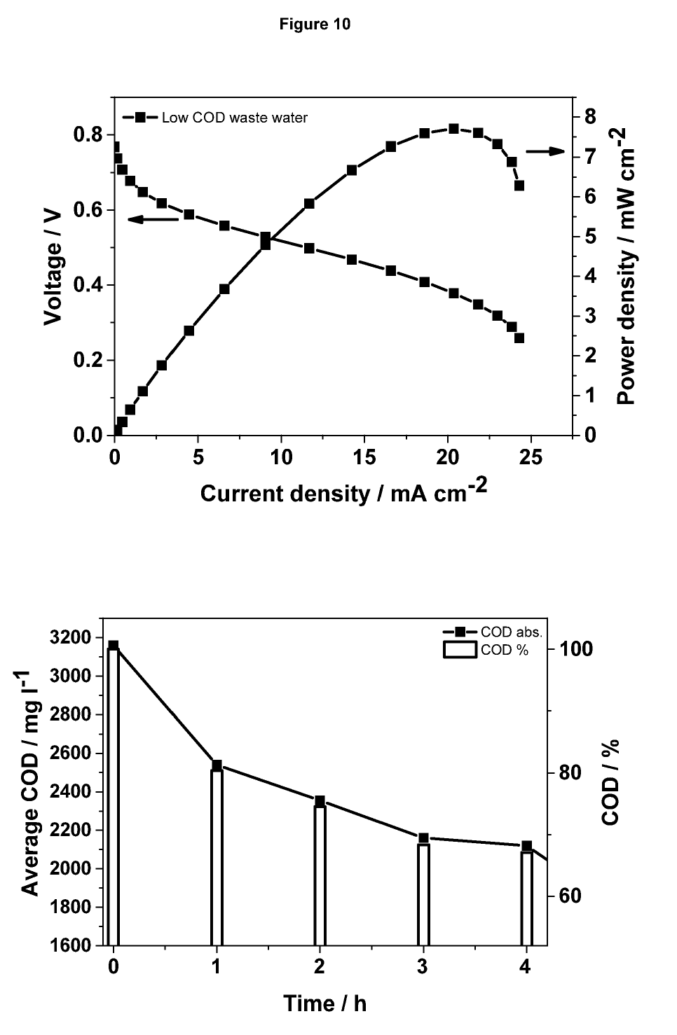

FIG. 10 shows the polarization curve employing a different batch of wastewater obtained from Tate and Lyle London and used at a pH of 13 (adjusted with NaOH). The Direct Waste Water Fuel Cell setup was as constructed in Example 1, anode: 2 mg _{Pt}/cm² Pt/Ru/C on Nickel foam, wastewater, 8 mL/min; cathode: 2.8 mg/cm² SG catalyst, dry air, 100 sccm. The COD was reduced by ca 35% after a recirculation of the liquid that equates to a residence time of ca. 3 minutes. The initial COD was about 3200 mg/L.

Embodiments of the invention have been described by way of example only. It will be appreciated that variations of the described embodiments may be made which are still within the scope of the invention.

1. A method for treating a waste stream comprising the steps of:
a) providing an electrochemical cell (preferably a fuel cell) comprising a cathode, and an anode;
b) supplying a waste stream comprising an organic compound which is a liquid or dissolved in a solvent and contacting the anode and cathode with the waste stream;
c) electrochemically oxidising the organic compound at the anode,
d) supplying oxygen to the cathode;
e) electrochemically reducing the oxygen at the cathode,
wherein the cathode comprises a poison resistant oxygen reduction catalyst.

2. (canceled)

3. The process of claim 1, wherein step c) involves directly electrochemically oxidising the organic compound at the anode, and wherein the anode comprises an anode catalyst, preferably wherein the anode catalyst comprises platinum, ruthenium or a combination thereof.

4. The process of claim 3, wherein the anode catalyst is supported by carbon or silver.

5. The process of claim 1, wherein step c) involves oxidising the organic compound using an anode mediator compound, preferably wherein the anode mediator compound is an organic dye, more preferably wherein the anode mediator compound is attached to the surface of the anode.

6. The process of claim 1, wherein step e) involves directly electrochemically reducing the oxygen at the cathode.

7. The process of claim 1, wherein the poison resistant oxygen reduction catalyst is prepared by:
(a) providing a reaction mixture comprising a nitrogen containing precursor compound, and optionally comprising a transition metal salt;
(b) optionally adding a carbon source and/or templating agent to the reaction mixture;
(c) polymerising the reaction mixture; and
(d) heating the polymer produced by step c) to a temperature of between about 400° C. to about 1200° C.

8. The process of claim 7, wherein the nitrogen containing precursor compound consists of hydrogen, nitrogen and carbon, and optionally sulphur and/or oxygen.

9. The process of claim 7, wherein the nitrogen containing precursor compound comprises i) one or more aryl or heteroaryl rings and at least one amine group, −NHR, which is attached directly to the aryl or heteroaryl ring(s), wherein each R is independently selected from H, aliphatic, heteroaliphatic, aryl and heteroaryl; or ii) at least one heteroaryl ring comprising at least one nitrogen atom and/or at least one sulphur atom, preferably wherein the nitrogen containing precursor compound is selected from:

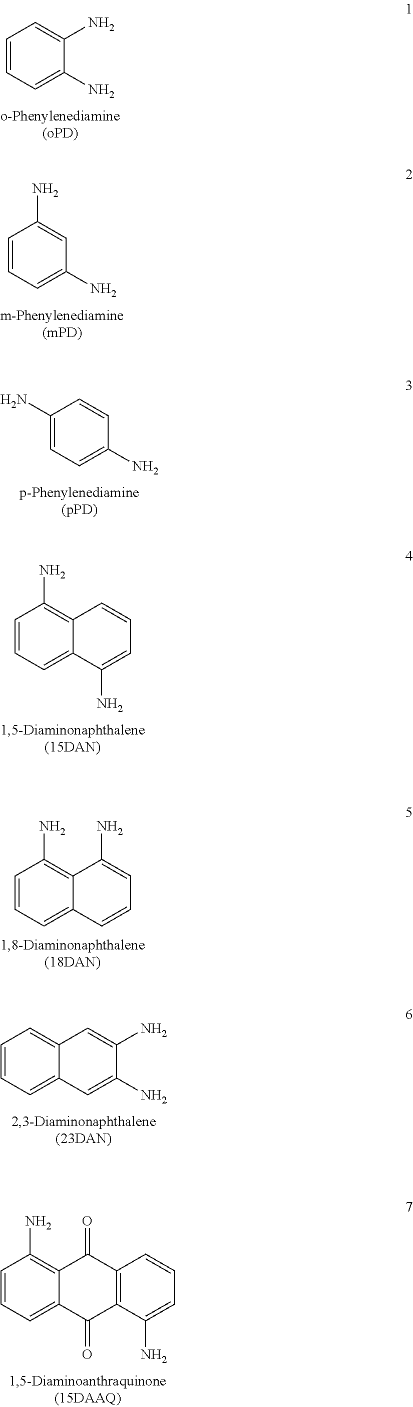

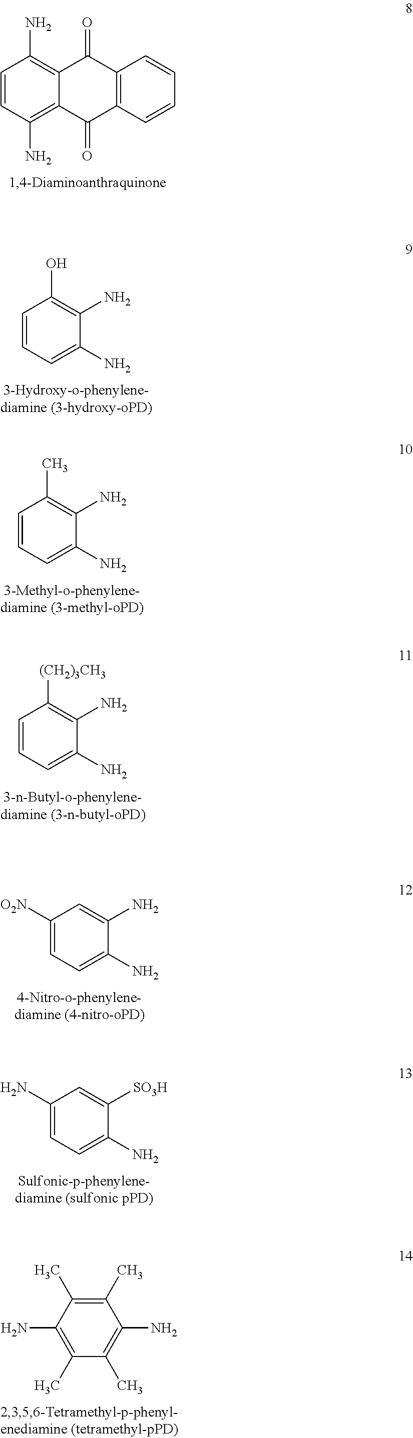

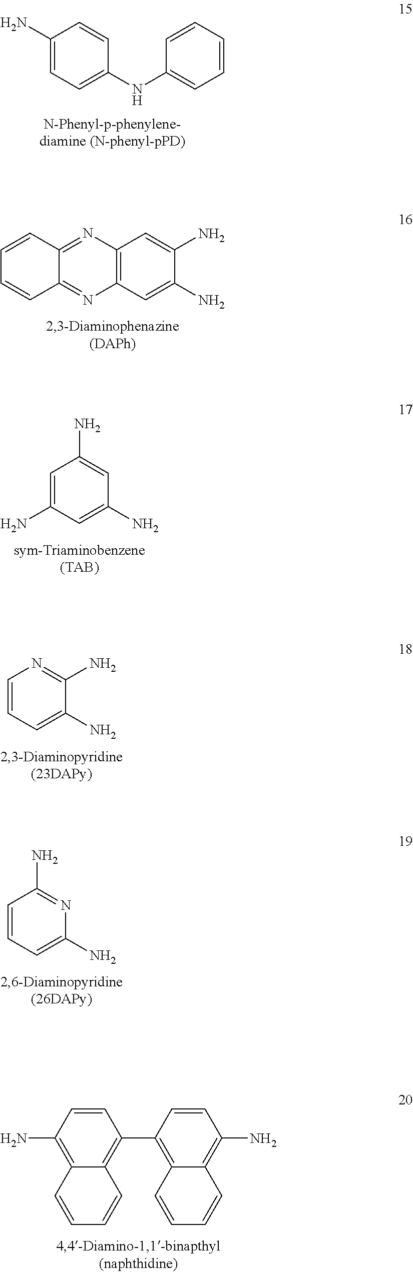 [SMILES: Nc1ccc(Nc2ccccc2)cc1 ; Nc1cc2nc3ccccc3nc2cc1N ; Nc1cc(N)cc(N)c1 ; Nc1cccnc1N ; Nc1cccc(N)n1 ; Nc1ccc(-c2ccc(N)c3ccccc23)c2ccccc12]

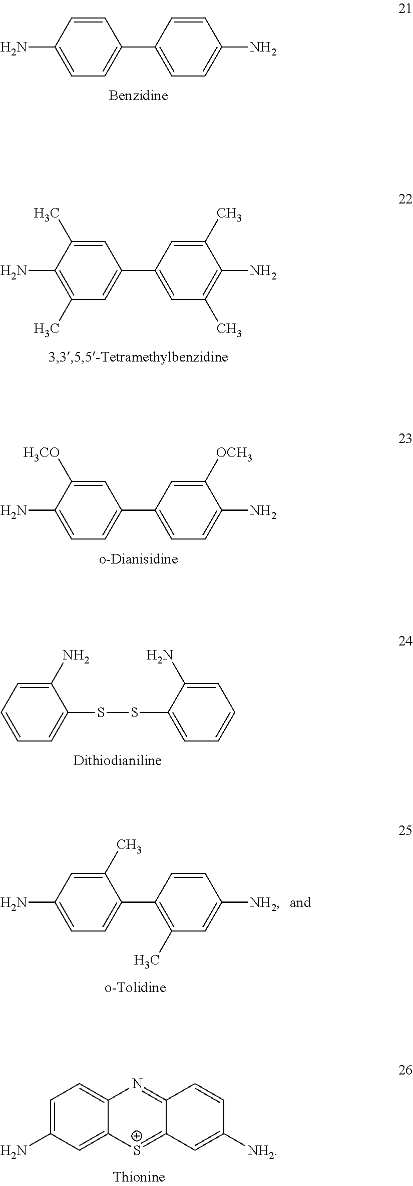 [SMILES: Nc1ccc(-c2ccc(N)cc2)cc1 ; Cc1cc(-c2cc(C)c(N)c(C)c2)cc(C)c1N ; COc1cc(-c2ccc(N)c(OC)c2)ccc1N ; Nc1ccccc1SSc1ccccc1N ; Cc1cc(N)ccc1-c1ccc(N)cc1C ; Nc1ccc2nc3ccc(N)cc3[s+]c2c1]

10. The process of claim 7, wherein the process for preparing the poison resistant oxygen reduction catalyst additionally comprises adding a templating agent, said templating agent preferably comprising, consisting essentially of or consisting of a metal oxide, metal hydroxide, metal carbonate, metal bicarbonate, metal nitrate, metal oxalate, metal formate, metal acetate or metal sulphate nanopowder of the formula Aⁱ(X^{j})ₙ, wherein A is an alkali metal, an alkaline earth metal, or a group 10-12 transition metal, i is the charge on the metal A, X is a counterion selected from an oxide, hydroxide, carbonate, bicarbonate, nitrate, oxalate, formate, acetate or sulphate, j is the charge on the counterion and i=n×j, more preferably wherein the metal oxide, metal carbonate or metal bicarbonate, even more preferably wherein A is Mg or Ca.

11. The process of claim 7, wherein the process for preparing the poison resistant oxygen reduction catalyst additionally comprises adding a carbon source, preferably wherein the carbon source is microporous carbon or nanoporous carbon.

12. The process of claim 1, wherein step e) involves reducing the oxygen using a cathode mediator compound, preferably wherein the cathode mediator compound is an organic dye or ferricyanide, more preferably wherein the cathode mediator compound is attached to the surface of the cathode.

13. The process of claim 1, wherein the poison resistant cathode catalyst is a material which comprises:
a) at least 75 wt % carbon; and
b) one or more of nitrogen, sulfur, oxygen and transition metal.

14. The process of claim 13, wherein the poison resistant cathode catalyst is a material which comprises:
a) at least 75 wt % carbon; and
b) one or more of:
i) nitrogen in an amount of up to 25 wt %,
ii) oxygen in an amount of up to 25 wt %,
iii) sulfur in an amount of up to 10 wt %, and
iv) transition metal in an amount of up to 25 wt %.

15. The process of claim 13, wherein transition metal present in the poison resistant cathode catalyst is selected from the group consisting of cobalt, manganese, chromium, iridium, rhodium, iron or a combination thereof, preferably wherein the transition metal is iron.

16. The process of claim 1, wherein the fuel cell does not contain a membrane (e.g. an ion conducting membrane).

17. The process of claim 1, wherein fuel cell comprises a porous separator which is disposed between the anode and the cathode.

18. The process of claim 1, wherein the fuel cell does not contain a porous separator, and the anode and cathode are separated by a gap, and wherein the waste stream is passed through the gap.

19. The process of claim 1, wherein said method is carried out at a temperature between about 10° C. and about 150° C.

20. The process of claim 1, wherein the organic compound is selected from:
(a) a carbohydrate, preferably wherein the carbohydrate is selected from a monosaccharide (such as glucose, galactose, fructose, mannose and ribose), a disaccharide (such as sucrose, lactose, maltose, isomaltose, isomaltulose, trehalose and trehalulose), an oligosaccharide (such as FOS, MOS or GOS), a polysaccharide (such as inulin), or mixtures thereof;
(b) an alcohol, preferably wherein the alcohol is a C₁₋₁₀ alcohol, such as methanol, ethanol, glycerol, isomalt, lactitol, maltitol, mannitol, sorbitol, xylitol, erythritol, or a combination thereof;
(c) an acid, preferably wherein the acid is a C₁₋₂₀ carboxylic acid or dicarboxylic acid, such as citric acid, tartaric acid, malic acid, lactic acid, acetic acid, propionic acid, or a combination thereof;
(d) an aldehyde, preferably wherein the aldehyde is selected from formaldehyde (methanal), acetaldehyde (ethanal), propionaldehyde (propanal), butyraldehyde (butanal), pentanal, benzaldehyde, cinnamaldehyde, vanillin, tolualdehyde, furfural, retinaldehyde, glyoxal, malondialdehyde, succindialdehyde, glutaraldehyde, phthalaldehyde or a combination thereof;
(e) a ketone, preferably wherein the ketone is selected from acetone, propanone, butanone, 3-pentanone, cyclohexanone, dimethyl ketone, methyl ethyl ketone, methyl isobutyl ketone, isophorone, or a combination thereof,
(f) a hydrocarbon, preferably wherein the hydrocarbon is a C₁₋₂₀ hydrocarbon, such as methane, ethane, propane, butane (n or iso), pentane (n, iso or cyclo), hexane (n, iso or cyclo), benzene, naphthalene, anthracene, phenanthracene, pyrene, chrysene or combinations thereof;
(g) an ester, preferably wherein the ester is selected from ethyl acetate, n-butyl acetate, n-propyl acetate, isopropyl acetate, ethyl formate, methyl formate or combinations thereof;
(h) an amino acid or a protein, preferably wherein the amino acid or protein is cysteine, lysine, or bovine serum albumin;
or a combination of any of (a) to (h).

21. The process of claim 1, wherein the solvent is water.

22. The process of claim 1, wherein the waste stream additionally comprises a nitrogen or sulphur containing compound, or a salt.

23. The process of claim 1, wherein the step of electrochemically reducing oxygen at the cathode results in the production of hydrogen peroxide and water and/or hydroxide ions.

24. A process for disinfecting a waste stream, the process comprising the steps of
a) providing an electrochemical cell (preferably a fuel cell) comprising a cathode, and an anode,
b) supplying a waste stream comprising an organic compound which is a liquid or dissolved in a solvent and contacting the anode and cathode with the waste stream;
c) electrochemically oxidising the organic compound at the anode,
d) supplying oxygen to the cathode,
e) electrochemically reducing the oxygen at the cathode, wherein the cathode comprises a poison resistant oxygen reduction catalyst, preferably wherein the anode comprises an anode catalyst supported on silver.

25. (canceled)
